(19) United States
(12) Patent Application Publication
(10) Pub. No.: US 2024/0063440 A1
(43) Pub. Date: Feb. 22, 2024

(54) LITHIUM-METAL UNIT CELLS AND METHODS OF FABRICATING THEREOF

(71) Applicant: Cuberg, Inc., San Leandro, CA (US)

(72) Inventor: Alun Thomas, Västerås (SE)

(73) Assignee: Cuberg, Inc., San Leandro, CA (US)

(21) Appl. No.: 18/451,004

(22) Filed: Aug. 16, 2023

Related U.S. Application Data
(60) Provisional application No. 63/371,661, filed on Aug. 17, 2022.
(60) Provisional application No. 63/495,806, filed on Apr. 13, 2023.

(51) Int. Cl. H01M 10/0585; H01M 10/052; H01M 4/134; H01M 4/38; H01M 50/46; H01M 4/04; H01M 4/1395

(52) U.S. Cl. CPC H01M 10/0585; H01M 10/052; H01M 4/134; H01M 4/382; H01M 50/46; H01M 4/0404; H01M 4/1395; H01M 2004/027

(57) ABSTRACT

Described herein are lithium-metal unit cells and methods of fabricating such cells. A lithium-metal unit cell comprises a negative electrode, a positive electrode, and a separator sheet. The negative electrode comprises a negative polymer base and a negative active material layer adhered to and supported on the negative polymer base and comprising lithium metal. The positive electrode comprises a positive polymer base, a positive current collector adhered to and supported on the positive polymer base, and a positive active material layer adhered to and supported on the positive polymer base such that the positive current collector is positioned between the positive polymer base and the positive active material layer. The separator sheet is positioned between the negative active material layer and the positive active material layer and bonded to the negative base side edges and the positive base side edges.

### CROSS-REFERENCE TO RELATED APPLICATIONS

This application claims the benefit under 35 U.S.C. § 119(e) of U.S. Provisional Patent Application No. 63/371,661, filed on 2022 Aug. 17, and U.S. Provisional Patent Application No. 63/495,806, filed on 2023 Apr. 13, both of which are incorporated herein by reference in their entirety for all purposes.

### BACKGROUND

Li-ion batteries are widely used for various applications, as small as medical devices or cell phones and as large as electric vehicles or aircraft. Lithium metal batteries represent a different battery type and are distinct from Li-ion batteries. Specifically, Li-ion batteries or, more specifically Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

Typically, Li-metal cells utilize solid or polymer electrolytes that provide support and maintain the alignment between the positive and negative electrodes. However, a specific subclass of Li-metal cells utilizes liquid electrolytes, similar to Li-ion cells. Unlike solid or polymer electrolytes, liquid electrolytes can not provide such support functions. A liquid electrolyte soaks a porous separator, which is positioned between the positive and negative electrodes, thereby providing ionic conductivity between the electrodes. The electrode support depends on the cell design. For example, in wound cells, most of the support is provided by friction/compression (among the electrodes and separator sheets). In stacked cells, the friction/compression support between the electrodes can be diminished. However, additional support can be provided by the tabs that are used for external connections to the electrodes.

It should be noted that the electrode support in any cell type is critical as it ensures the alignment of positive and negative electrodes. Specifically, this alignment provides that all (or at least most) lithium ions released from the positive electrode (during the cell charging) are captured by the corresponding negative electrode. Without the alignment, lithium can be plated in undesirable locations causing internal cell shorts and potentially catastrophic failures.

What is needed are new methods and devices for aligning positive and negative electrodes in batteries.

### SUMMARY

Described herein are lithium-metal unit cells and methods of fabricating such cells. A lithium-metal unit cell comprises a negative electrode, a positive electrode, and a separator sheet. The negative electrode comprises a negative polymer base and a negative active material layer adhered to and supported on the negative polymer base and comprising lithium metal. The positive electrode comprises a positive polymer base, a positive current collector adhered to and supported on the positive polymer base, and a positive active material layer adhered to and supported on the positive polymer base. The terms “positive” and “negative” are used herein for differentiating purposes (i.e., to differentiate two types of electrodes forming electrochemical cells) and not to imply the voltage/potential of any components. Concerning electrodes and electrode components, the term “positive” can be used interchangeably with the term “first”, while the term “negative” can be used interchangeably with the term “second.”

The positive current collector is positioned between the positive polymer base and the positive active material layer. The separator sheet is positioned between the negative active material layer and the positive active material layer and bonded to the negative base side edges and the positive base side edges.

In some aspects, the techniques described herein relate to a lithium-metal unit cell including: a negative electrode, including a negative polymer base and a negative active material layer adhered to and supported on the negative polymer base and including lithium metal, wherein the negative polymer base includes negative base side edges uncovered by the negative active material layer; a positive electrode including a positive polymer base, a positive current collector adhered to and supported on the positive polymer base, and a positive active material layer adhered to and supported on the positive polymer base such that the positive current collector is positioned between the positive polymer base and the positive active material layer, wherein the positive polymer base includes positive base side edges uncovered by the positive active material layer; and a separator sheet, positioned between the negative active material layer and the positive active material layer and bonded to the negative base side edges and the positive base side edges.

In some aspects, the techniques described herein relate to a lithium-metal unit cell, wherein the negative electrode further includes a negative current collector adhered to and supported on the negative polymer base such that the negative current collector is positioned between the negative polymer base and the negative active material layer.

In some aspects, the techniques described herein relate to a lithium-metal unit cell, wherein the negative active material layer directly interfaces and adheres to the negative polymer base.

In some aspects, the techniques described herein relate to a lithium-metal unit cell, further including: an additional negative electrode, including an additional negative polymer base and an additional negative active material layer adhered to and supported on the additional negative polymer base, wherein the additional negative polymer base includes additional negative base side edges uncovered by the additional negative active material layer; and an additional separator sheet, wherein: the positive electrode further includes an additional positive current collector adhered to and supported on the positive polymer base such that the positive polymer base is positioned between the positive current collector and the additional positive current collector, the positive electrode further includes an additional positive active material layer adhered to and supported on the positive polymer base such that the additional positive current collector is positioned between the positive polymer base and the additional positive active material layer, and the additional separator sheet is positioned between the additional negative active material layer and the additional positive active material layer and bonded to the negative base side edges, the positive base side edges, and the separator sheet.

In some aspects, the techniques described herein relate to a lithium-metal unit cell, wherein: a portion of the positive current collector is uncovered by the positive active material layer and forms a positive tab, and the positive tab fully overlaps with and is adhered to and supported on the positive polymer base.

In some aspects, the techniques described herein relate to a lithium-metal unit cell, wherein: a portion of the negative active material layer, extending past a boundary of the positive polymer base forms a negative tab, the positive tab extends past a boundary of the negative polymer base, and the positive tab and the negative tab extend from the positive active material layer in opposite directions.

In some aspects, the techniques described herein relate to a lithium-metal unit cell, wherein the negative active material layer has a thickness of less than 10 micrometers.

In some aspects, the techniques described herein relate to a lithium-metal unit cell, wherein the positive current collector has a thickness of less than 1 micrometer.

In some aspects, the techniques described herein relate to a lithium-metal unit cell, wherein the negative polymer base has a thickness of less than 15 micrometers.

In some aspects, the techniques described herein relate to a lithium-metal unit cell, wherein the positive polymer base has a thickness of less than 15 micrometers.

In some aspects, the techniques described herein relate to a lithium-metal unit cell, wherein at least one of the negative polymer base and the positive polymer base includes a polymer selected from the group consisting of polyimide (PI), polyethylene terephthalate (PET) and polyethylene terephthalate glycol (PETG).

In some aspects, the techniques described herein relate to a lithium-metal unit cell, wherein the separator sheet is bonded to the negative base side edges and the positive base side edges using heat bonding.

In some aspects, the techniques described herein relate to a lithium-metal unit cell, wherein the separator sheet is bonded to the negative base side edges and the positive base side edges using mechanical stitching.

In some aspects, the techniques described herein relate to a multi-cell assembly including: a unit lithium-metal cell and an additional lithium-metal unit cell, each including a negative electrode, including a negative polymer base and a negative active material layer adhered to and supported on the negative polymer base and including lithium metal, wherein the negative polymer base includes negative base side edges uncovered by the negative active material layer; a positive electrode including a positive polymer base, a positive current collector adhered to and supported on the positive polymer base, and a positive active material layer adhered to and supported on the positive polymer base such that the positive current collector is positioned between the positive polymer base and the positive active material layer, wherein the positive polymer base includes positive base side edges uncovered by the positive active material layer; and a separator sheet, positioned between the negative active material layer and the positive active material layer and bonded to the negative base side edges and the positive base side edges, wherein the negative polymer base or the positive polymer base of the unit cell directly interfaces the additional lithium-metal unit cell.

In some aspects, the techniques described herein relate to a multi-cell assembly, wherein the separator sheet of the unit cell and the separator sheet of the additional lithium-metal unit cell are stacked, directly interface with each other, and interconnected thereby supporting the lithium-metal unit cell and the additional lithium-metal unit cell relative to each other.

In some aspects, the techniques described herein relate to a multi-cell assembly, further including a first assembly insulator and a second assembly insulator attached to each other around edges of the lithium-metal unit cell and the additional lithium-metal unit cell and at least partially enclosing the lithium-metal unit cell and the additional lithium-metal unit cell and define assembly edges.

In some aspects, the techniques described herein relate to a multi-cell assembly, wherein the negative polymer base and the positive polymer base of each of the lithium-metal unit cell and the additional lithium-metal unit cell are positioned away from the assembly edges.

In some aspects, the techniques described herein relate to a multi-cell assembly, wherein the negative polymer base and the positive polymer base of each of the lithium-metal unit cell and the additional lithium-metal unit cell extend to the assembly edges and stacked together with the first assembly insulator and the second assembly insulator, collectively forming the assembly edges.

In some aspects, the techniques described herein relate to a multi-cell assembly, further including a liquid electrolyte such that the multi-cell assembly is a lithium-metal liquid-electrolyte electrochemical cell.

In some aspects, the techniques described herein relate to a method of fabricating a lithium-metal unit cell, the method including: depositing a negative active material layer over a negative polymer base, wherein the negative polymer base includes negative base side edges uncovered by the negative active material layer, thereby forming a negative electrode; depositing a positive current collector over a positive polymer base, wherein the positive polymer base includes positive base side edges uncovered by the positive current collector; depositing a positive active material layer over the positive current collector such that the positive current collector is positioned between the positive polymer base and the positive active material layer, thereby forming a positive electrode; stacking the negative electrode, the positive electrode, and a separator sheet positioned between the negative electrode and the positive electrode; and bonding the negative base side edges, the positive base side edges, and the separator sheet.

These and other embodiments are described further below with reference to the figures.

### BRIEF DESCRIPTION OF THE DRAWINGS

FIG. 1A is a schematic top view of a stacked electrochemical cell illustrating the relative positions of the electrodes and separator in the cell, in accordance with some examples.

FIG. 1B is a schematic cross-sectional view of one edge of the stacked electrochemical cell in FIG. 1A, illustrating the relative positions of the electrodes and separator in the cell, in accordance with some examples.

FIGS. 1C and 1D are schematic cross-sectional views of two examples of a lithium-metal unit cell comprising a negative electrode comprising a negative polymer base, a positive electrode comprising a positive polymer base, and a separator sheet positioned between the negative and positive electrodes and also bonded to the edges of both negative polymer base and positive polymer base.

FIG. 2A is a schematic cross-sectional view of a negative electrode comprising a negative polymer base, a negative current collector, and a negative active material layer, in accordance with some examples.

FIGS. 2B and 2C are schematic top and bottom views of the negative electrode in FIG. 2A, in accordance with some examples.

FIG. 2D is a schematic cross-sectional view of a negative electrode comprising a negative polymer base and a negative active material layer disposed directly on the polymer base, in accordance with some examples.

FIGS. 2E and 2F are schematic top and bottom views of the negative electrode in FIG. 2D, in accordance with some examples.

FIG. 3A is a schematic cross-sectional view of a single-sided positive electrode comprising a positive polymer base, a positive current collector, and a positive active material layer, in accordance with some examples.

FIGS. 3B and 3C are schematic top and bottom views of the positive electrode in FIG. 3A, in accordance with some examples.

FIG. 3D is a schematic cross-sectional view of a double-sided positive electrode comprising a positive polymer base, a positive current collector, a positive active material layer, an additional positive current collector, and an additional positive active material layer in accordance with some examples.

FIGS. 3E and 3F are schematic top and bottom views of the positive electrode in FIG. 3D, in accordance with some examples.

FIG. 4A is a schematic cross-sectional view of a lithium-metal unit cell comprising the two negative electrodes of FIG. 2A and the double-sides positive electrode of FIG. 3D, in accordance with some examples.

FIG. 4B is a schematic cross-sectional view of a lithium-metal unit cell with a single polymer base supporting both positive and negative active material layers, in accordance with some examples.

FIGS. 4C and 4D are schematic top and bottom views of the lithium-metal unit cell of FIG. 4A or FIG. 4B, in accordance with some examples.

FIGS. 4E, 4F, 4G, 4H, and 4I are various examples of connection features formed by bonding at least one separator sheet to at least one negative base side edge and at least one positive base side edge, in accordance with some examples.

FIGS. 4J and 4K are schematic side cross-sectional views of two examples of a lithium-metal unit cell illustrating the positive and negative tabs of the cell, in accordance with some examples.

FIG. 5A is a schematic cross-sectional view of a multi-cell assembly comprising at least two unit cells, in accordance with some examples.

FIG. 5B is a schematic cross-sectional view of a multi-cell assembly illustrating various tab connections among the cells, in accordance with some examples.

FIG. 5C is a schematic cross-sectional view of another example of a multi-cell assembly, in accordance with some examples.

FIG. 6 is a process flowchart corresponding to a method of fabricating a lithium-metal unit cell and further using this cell to fabricate a multi-cell assembly, in accordance with some examples.

FIGS. 7A and 7B are schematic views of different stages during the fabrication of negative electrodes, in accordance with some examples.

FIGS. 8A and 8B are schematic views of different stages during the fabrication of positive electrodes, in accordance with some examples.

FIGS. 9A-9F are schematic cross-sectional views of interconnecting lithium-metal unit cells in a multi-cell assembly, in accordance with some examples.

FIG. 9G is a schematic top view of a negative electrode comprising a positive

FIG. 10A illustrates a cross-sectional view of a continuous cell assembly, in accordance with some examples.

FIG. 10B illustrates a top view of the continuous cell assembly in FIG. 10A in an unfolded state, in accordance with some examples.

FIG. 10C illustrates a cross-section side view of a portion of the continuous cell assembly in FIG. 10B, showing the arrangement of different cell components, in accordance with some examples.

FIG. 10D illustrates another cross-section side view of the continuous cell assembly in FIG. 10B, in accordance with some examples.

FIG. 10E illustrates a side cross-section view of a portion of the continuous cell assembly in FIG. 10B after its folding, in accordance with some examples.

FIG. 10F illustrates the top cross-section view of the continuous cell assembly in FIG. 10E, in accordance with some examples.

FIG. 11A illustrates a top planar view of a negative substrate for use in a continuous cell assembly, in accordance with some examples.

FIG. 11B illustrates a top planar view of a negative electrode for use in a continuous cell assembly and comprising the negative substrate FIG. 11A, in accordance with some examples.

FIG. 11C illustrates a top planar view of a positive substrate for use in a continuous cell assembly, in accordance with some examples.

FIG. 11D illustrates a top planar view of a positive electrode for use in a continuous cell assembly and comprising the positive substrate FIG. 11C, in accordance with some examples.

FIG. 11E illustrates a continuous cell assembly in its folded state and comprising the negative electrode in FIG. 11B and the positive electrode in FIG. 11D, in accordance with some examples.

FIG. 11F illustrates another example of continuous cell assembly in its folded state in which portions of the negative substrate are arranged into negative tabs and portions of the positive substrate are arranged into positive tabs, in accordance with some examples.

FIG. 12 is a block diagram illustrating an electric vehicle comprising a multi-cell assembly, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### INTRODUCTION

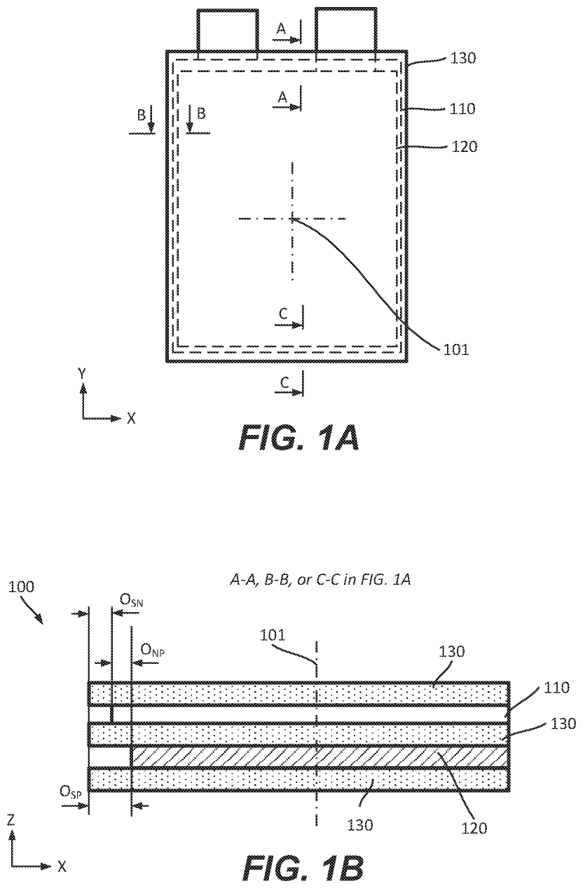

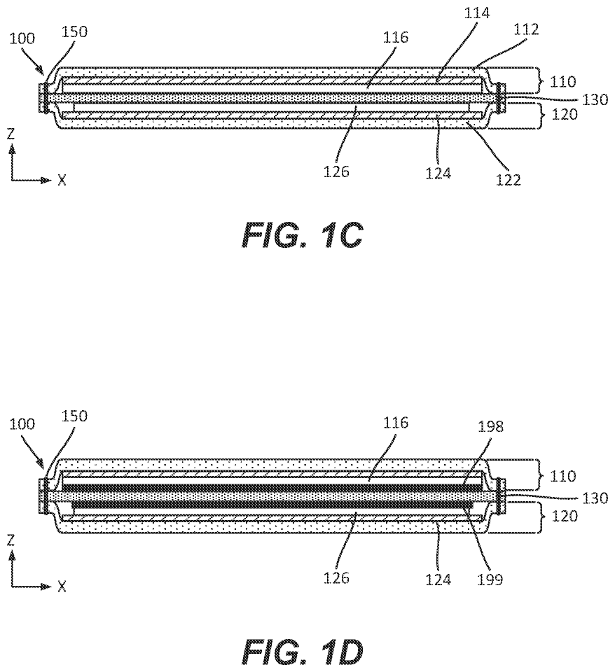

Electrode alignment is critical to the performance and safety of electrochemical cells. Specifically, the footprint of a negative active material layer has to cover the entire footprint of the corresponding positive active material layer to ensure that, during the cell charging, all lithium ions released by the positive active material layer are directed to the negative active material layer and do not form lithium deposits elsewhere within the cell. This footprint alignment is schematically shown in FIGS. 1A and 1B. Specifically, FIG. 1A is a schematic top view of a stacked electrochemical cell illustrating the relative positions of negative electrode 110, positive electrode 120, and separator sheet 130. FIG. 1B is a schematic cross-sectional view of one edge of the stacked electrochemical cell in FIG. 1A. Negative electrode 110 extends past the footprint of positive electrode 120 as reflected by the negative-positive offset (O_{NP}). This target offset depends on the alignment precision and other factors and can be up to 10 millimeters or, more specifically, up to 5 millimeters, such as between 0.01 millimeters and 10 millimeters or, more specifically, between 0.1 millimeters and 3 millimeters. Furthermore, separator sheet 130 protrudes past negative electrode 110, which may be referred to as the separator-positive offset (O_{SN}) and which can be up to 10 millimeters or, more specifically, up to 5 millimeters, such as between 0.01 millimeters and 10 millimeters or, more specifically, between 0.1 millimeters and 3 millimeters. Similarly, separator sheet 130 protrudes past positive electrode 120, which may be referred to as the separator-positive offset (O_{SP}) and which can be up to 10 millimeters or, more specifically, up to 5 millimeters, such as between 0.01 millimeters and 10 millimeters or, more specifically, between 0.1 millimeters and 3 millimeters. These separator offsets ensure that negative electrode 110 and positive electrode 120 do not form direct electrical connections along the edges. It should be noted that all offsets listed above occupy the space inside the battery without contributing to the battery capacity, which reduces the volumetric capacity of the battery. As such, reducing these offsets are highly desirable.

However, achieving this precise electrode alignment can be difficult, especially in stacked cells and at high production speeds. For example, once an electrode is added to a stack and aligned, stack handling operations and even cell handling operations (e.g., post-fabrication) can cause movement and potential misalignment of this electrode. The primary support of this electrode in the stack is provided by its current transferring tab (e.g., welded to other tabs after stacking) and friction between this electrode and adjacent separator layers. In some examples, the position and size of this tab are not ideally positioned for maintaining electrode alignment (e.g., relative to the overall size of the electrode). For example, it may be difficult to maintain the alignment of a long electrode with a single tab positioned on the short side of this electrode. Furthermore, the friction between this electrode and adjacent separator layers can be minimal during some cell fabrication steps and even post-fabrication (e.g., standalone pouch cells).

One difficulty with the electrode alignment results from each electrode being separated from adjacent electrodes by separator sheets such that the edges of these separator sheets extend past the edges of these electrodes as, e.g., is schematically shown in FIG. 1B. This edge offset is needed to prevent electrical shorts between positive and negative electrodes as described below. As such, the electrode edges and corners are mostly not accessible for alignment. The only electrode components extending past the separator edges are current transferring tabs as, e.g., schematically shown in FIG. 1A. Additional difficulties come from the high-speed nature of various operations (e.g., stacking), the inherent variability of dimensions (e.g., thickness) of incoming components, the fragility of electrodes, and other like factors.

It should be noted that sheet-to-sheet alignment (i.e., the alignment of two adjacent sheets) is generally straightforward. However, when a stack includes multiple disjoined components (such as negative electrodes, positive electrodes, and separator sheets), the alignment of these components (often 50+ components) at the same time can be very challenging. Furthermore, when a continuous separator sheet is used in a Z-fold configuration, the control of the electrode dimensioning and alignment in all four corners is not possible. As such, the dimension validation is done via inferred distances which allow for some variability. Units cells, described herein, address this issue by allowing the full view of all electrode corners at once and allowing precise centering of specific electrode locations with respect to its opposing electrode.

Furthermore, taping of the stacked electrodes, which are wrapped in loose separator material, can interfere with the overall battery performance due to the uneven compression (both during formation/conditioning cycles and when the cell itself is placed into a larger form factor, such as module or packs). Units cells, described herein, eliminate the need for the tape. It should be also noted that conventional Z-folding of the separator sheet requires additional wrapping layers of the separator material. This ensures that the stacked cell layers, when taped, are unable to move from the stacking process as the cell moves through later assembly stages. Again, unit cells, described herein, eliminate the need for any external separation material to be wrapped around the cell. Furthermore, Z-folding can complicate the alignment and ensure that the electrode surfaces are free from damage and/or variation when handling and stacking. This is becoming a larger problem as battery designs move to thinner separator sheets. Units cells, described herein, eliminate the need for folding or manipulating these separator sheets. These unit cells also eliminate the need for cutting discreet electrodes and allow for roll feeding of cell stacking machines as further described below. Units cells, described herein, also allow the welding of discreet layers instead of welding an entire stack. It should be mentioned that minimal polymer inclusions into welding joints provided by The lithium-metal unit cell s improve either conductivity/mechanical strength.

### Examples of Lithium-Metal Unit Cells

FIGS. 1C and 1D are schematic cross-sectional view of lithium-metal unit cell 100, in accordance with some examples. Lithium-metal unit cell 100 comprises negative electrode 110, positive electrode 120, and separator sheet 130 positioned between negative electrode 110 and positive electrode 120. Prior to the integration of lithium-metal unit cell 100 into a lithium-metal battery, separator sheet 130 provides physical separation between negative electrode 110 and positive electrode 120. Once a part of the lithium-metal battery and with electrolyte added (e.g., soaked into the pores of separator sheet 130), this electrolyte provides ionic conductivity between negative electrode 110 and positive electrode 120.

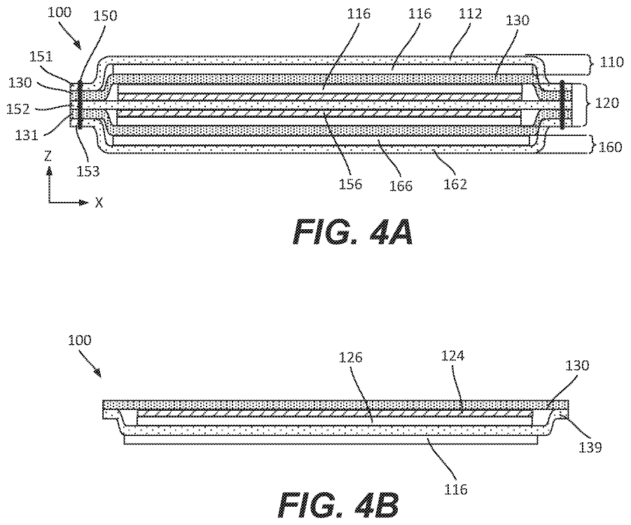

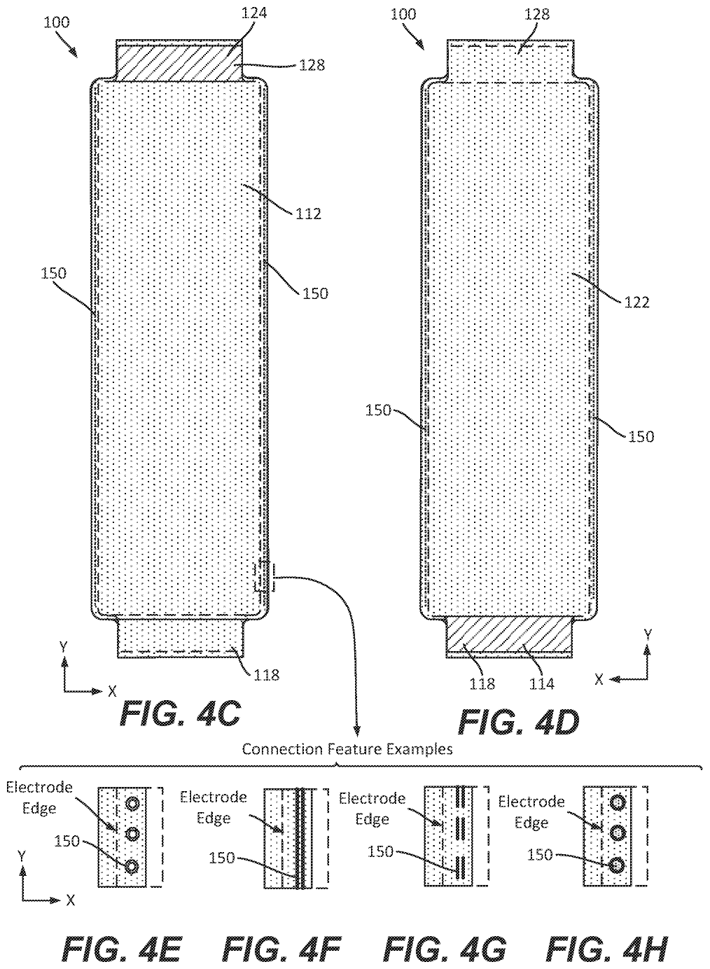

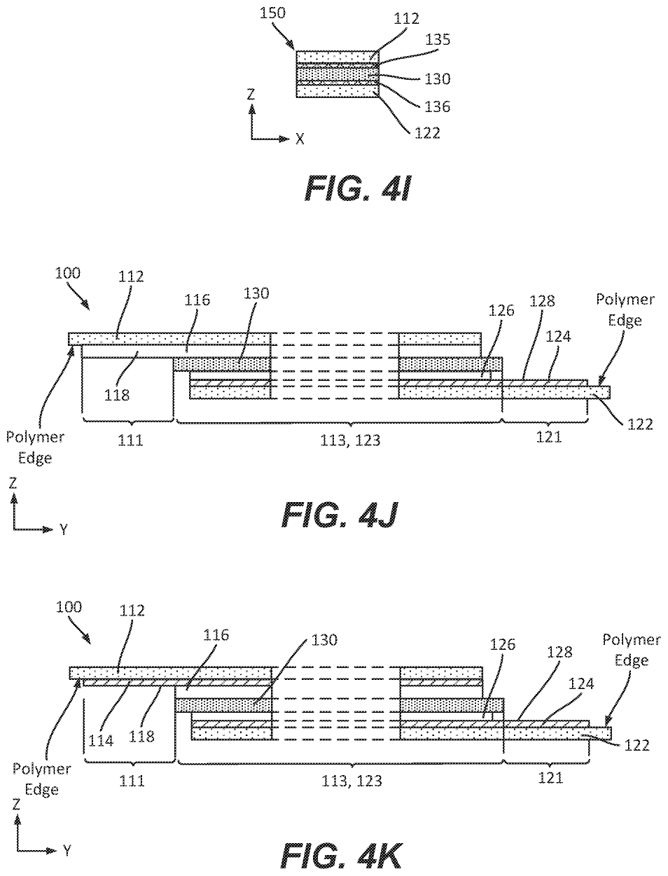

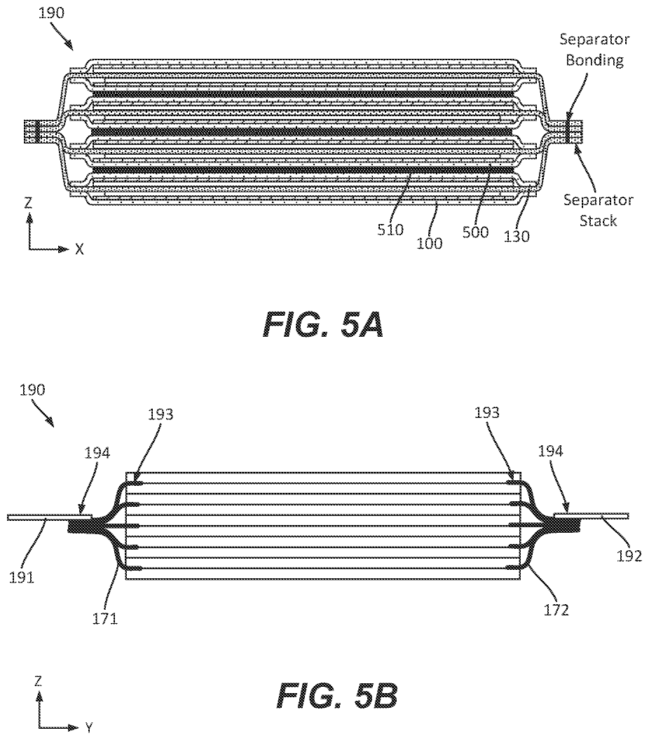

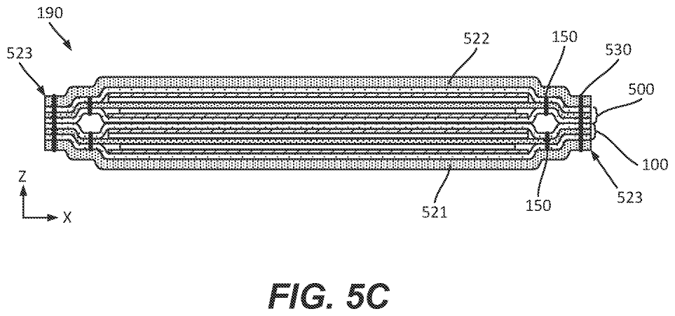

It should be noted that lithium-metal unit cell 100 is a standalone integrated structure with various components listed above. Lithium-metal unit cell 100 can be used as an independent cell or integrated/interconnected with other lithium-metal unit cells as further described below as, e.g., shown described below with reference to FIGS. 5A and 5B. Furthermore, FIG. 1C illustrates one example of lithium-metal unit cell 100. Additional examples are described below with reference to FIGS. 4A and 4B.

Referring to FIGS. 1C and 1D, in some examples, negative electrode 110 comprises negative active material layer 116, while positive electrode 120 comprises positive active material layer 126, aligned with negative active material layer 116 within lithium-metal unit cell 100. Various components of lithium-metal unit cell 100 providing and maintaining this alignment are described below.

In some examples, positive active material layer 126 comprises positive active material (e.g., in the form of particles) and binder (e.g., a polymer binder). Some examples of positive active materials include, but are not limited to, lithium nickel manganese cobalt (NMC) oxides, lithium iron phosphate, and the like. Some examples of suitable polymer binders include, but are not limited to, polymer binders (e.g., polyvinylidene-fluoride (PVDF), styrene-butadiene rubber (SBR), and carboxyl methyl cellulose (CMC)). In some examples, positive active material layer 126 comprises conductive additive (e.g., carbon black/paracrystalline carbon).

In some examples, positive active material layer 126 comprises single-crystal nickel-manganese-cobalt (NMC)-containing structures. The single-crystal NMC-containing structures can have a nickel concentration of at least 70% atomic or even at least 80% atomic. Because the bonds within the primary particles are stronger than between primary particles (in polycrystalline materials), single-crystal NMC particles inherently do not have or show intergranular cracking in a way that polycrystalline NMC particles do. Furthermore, single-crystal NMC particles tend to have higher specific capacities due to the greater surface-area-to-volume ratio of the individual particles vs. secondary-particle agglomerates of polycrystalline NMC materials. However, single-crystal NMC particles tend to have slower lithium transport kinetics than polycrystalline materials. As such, increased temperatures during the charge portion of the cycle help with increasing the rate of lithium-ion extraction from single-crystal NMC particles.

In some examples, single-crystal NMC particles are used with liquid electrolyte comprising one or more imide-containing salts, such as bis(trifluoromethanesulfonyl)imide (TFSI⁻)-containing salts, bis(fluorosulfonyl)imide (FSI⁻)-containing salts, and bis(pentafluoroethanesulfonyl)imide (BETI⁻)-containing salts. These salts can also include various cations, such as lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺). For example, imide-containing salts can act as a source of lithium ions in lithium-metal salts. In some examples, the liquid electrolyte further comprises one or more of 2,2,2-Trifluoroethyl Ether (TFEE), 1,1,2,2-Tetrafluoroethyl 2,2,3,3-tetrafluoropropyl ether (TFPE), one or more phosphites, and one or more phosphates.

Referring to FIG. 1C, in some examples, negative active material layer 116 directly interfaces separator sheet 130 and/or positive active material layer 126 directly interfaces separator sheet 130. In these examples, the support between negative electrode 110, positive electrode 120, and separator sheet 130 can be provided primarily along the edges of these components (e.g., using connection features 150 further described below).

Referring to FIG. 1D, in some examples, lithium-metal unit cell 100 comprises first adhesive layer 198 and second adhesive layer 199 providing support in this stack. Specifically, first adhesive layer 198 is positioned between negative active material layer 116 and separator sheet 130 (and initially can be a part of either one of these components). Similarly, second adhesive layer 199 is positioned between positive active material layer 126 and separator sheet 130 (and initially can be a part of either one of these components).

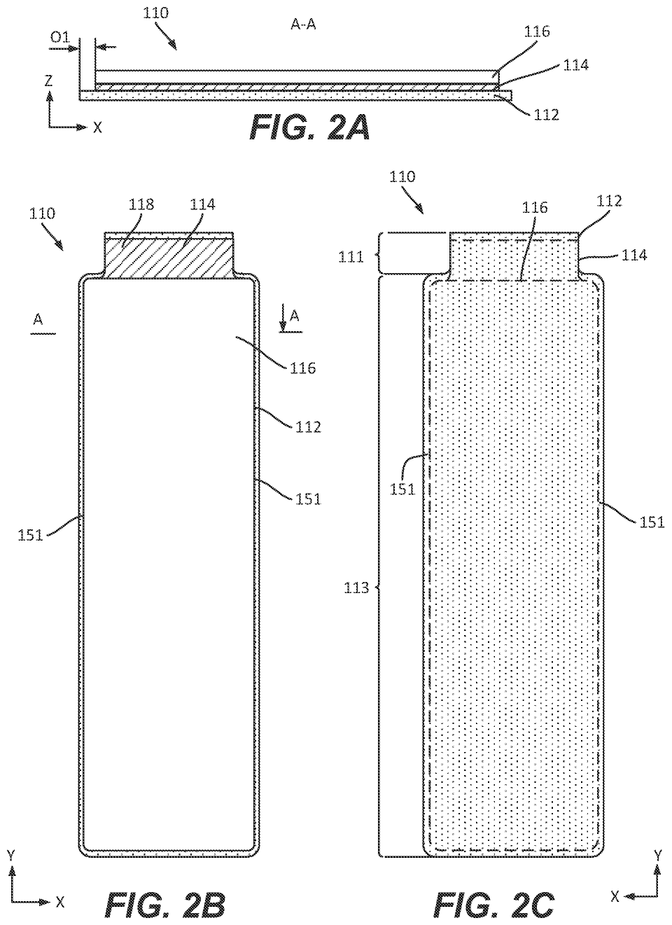

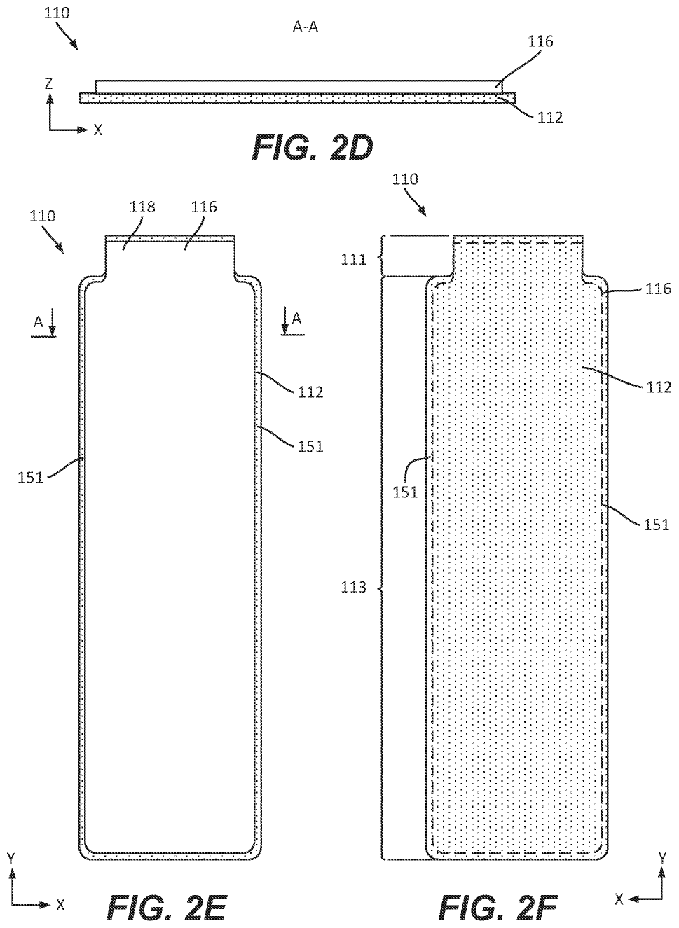

Referring to FIGS. 2A-2F, negative electrode 110 comprises negative polymer base 112 and negative active material layer 116 adhered to and supported on negative polymer base 112. The negative active material layer 116 may comprise lithium metal (e.g. when the lithium-metal unit cell is a lithium-metal unit cell). Lithium metal can be a part of an alloy, e.g., comprising one or more other metals and/or non-metal materials. It should be noted that various unit cell examples described herein can be used for other types of cells, e.g., lithium-ion cells, in which case, negative active material layer 116 may comprise other components. For example, negative active material layer 116 can comprise graphite and/or silicon structures.

Referring to FIGS. 2A-2C, in some examples, negative electrode 110 further comprises negative current collector 114 adhered to and supported on negative polymer base 112 such that negative current collector 114 is positioned between negative polymer base 112 and negative active material layer 116. For example, negative current collector 114 can be a thin metal (e.g., copper) film deposited (e.g., using physical vapor deposition (PVD)) directly onto negative polymer base 112. Various protection and lithiophilic layers can be positioned between negative current collector 114 and negative active material layer 116 (e.g., a lithium-metal layer). For example, a protection layer can comprise a protection-layer material selected from the group consisting of copper, silicon, zinc, magnesium, nickel, molybdenum, tungsten, tantalum, and silver. In some examples, a protection layer has a thickness of between 10 nanometers and 200 nanometers or, more specifically, between 25 nanometers and 100 nanometers.

Referring to FIGS. 2D-2F, in other examples, negative active material layer 116 directly interfaces and adheres to negative polymer base 112. For example, a layer of lithium metal may be deposited (e.g., using PVD) onto negative polymer base 112.

In either case, negative polymer base 112 comprises negative base side edges 151 uncovered by negative active material layer 116 (and also uncovered by negative current collector 114, if one is present). Negative base side edges 151 are used for bonding to other components of lithium-metal unit cell 100 as, e.g., further described below. In some examples, negative base side edges 151 protrude from negative active material layer 116 by up to 10 millimeters or, more specifically, up to 5 millimeters, such as between 0.01 millimeters and 10 millimeters or, more specifically, between 0.1 millimeters and 3 millimeters. Negative base side edges 151 can be two opposite side edges, both extending parallel to negative tab 118. In some examples, negative base side edges 151 further comprise additional edges (e.g., extending past the negative tab) and/or extending in the direction opposite of negative tab 118.

Referring to FIGS. 2C and 2F, one side of negative electrode 110 can be fully formed by negative polymer base 112. This full-side coverage in addition to negative base side edges 151 can be used to protect negative active material layer 116 when handling negative electrode 110.

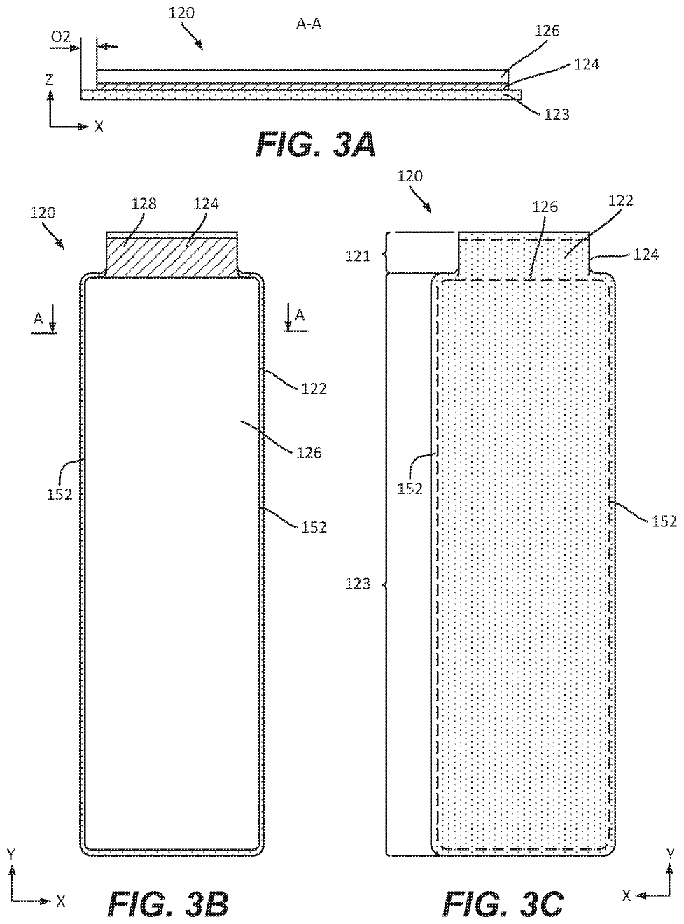

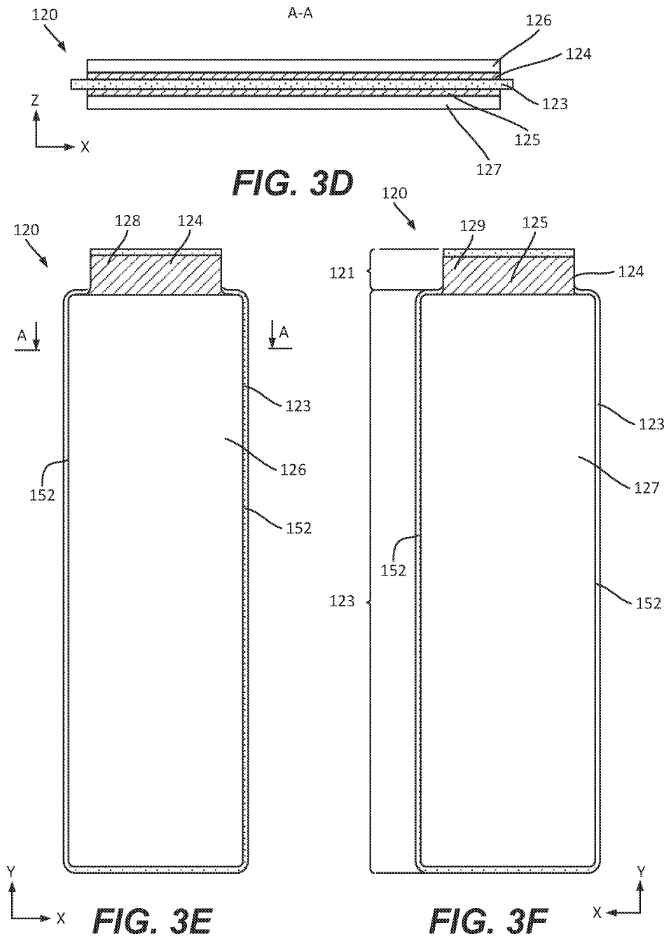

Referring to FIGS. 3A-3F, positive electrode 120 comprises positive polymer base 122 and positive current collector 124 adhered to and supported on positive polymer base 122. For example, a thin layer of metal (e.g., aluminum) can be deposited (e.g., using PVD) onto positive polymer base 122. Positive electrode 120 further comprises positive active material layer 126, which is adhered to and supported on positive polymer base 122. Specifically, positive current collector 124 is positioned between positive polymer base 122 and positive active material layer 126. Furthermore, positive polymer base 122 comprises positive base side edges 152 uncovered by positive active material layer 126 and, in some examples, by positive current collector 124. In some examples, positive base side edges 152 protrude from positive active material layer 126 by up to 10 millimeters or, more specifically, up to 5 millimeters, such as between 0.01 millimeters and 10 millimeters or, more specifically, between 0.1 millimeters and 3 millimeters. Positive base side edges 152 can be two opposite side edges, both extending parallel to positive tab 128. In some examples, positive base side edges 152 further comprise additional edges (e.g., extending past positive tab 128) and/or extending in the direction opposite of positive tab 128. Positive tab 128 extends from positive active material layer 126 and this portion of positive electrode 120 can be referred to as positive-electrode tab portion 121. A portion of positive electrode 120 away from positive tab 128 and, at least partially covered by positive active material layer 126, can be referred to as positive-electrode primary portion 123.

Referring to FIGS. 3A-3C, in some examples, one side of positive polymer base 122 is uncovered. In other words, positive current collector 124 (and positive active material layer 126) are positioned only on one side of positive polymer base 122. In these examples, positive electrode 120 can be referred to as a one-side positive electrode. In these examples, this full-side coverage (by positive polymer base 122) in addition to positive base side edges 152 can be used to protect positive active material layer 126 when handling positive electrode 120.

Referring to FIGS. 3D-3F, in some examples, positive electrode 120 further comprises additional positive current collector 125 adhered to and supported on positive polymer base 122 such that positive polymer base 122 is positioned between positive current collector 124 and additional positive current collector 125. Positive electrode 120 further comprises additional positive active material layer 127, which is adhered to and supported on positive polymer base 122, such that additional positive current collector 125 is positioned between positive polymer base 122 and additional positive active material layer 127. In these examples, positive electrode 120 can be referred to as a two-sided positive electrode. As such, a two-sided positive electrode comprises two positive current collectors (positioned on each side of positive polymer base 122) and two positive active material layers (forming external surfaces of this electrode). Without being restricted to any particular theory, ut us believed that a mirror-image-like structure of the two-sided positive electrode makes the processing of the two-sided positive electrode (e.g., roll pressing) easier than, for example, that of a single-sided positive electrode.

The one-side positive electrode can be combined with negative electrode 110 and one instance of separator sheet 130 to form lithium-metal unit cell 100 as, e.g., shown in FIG. 1C. In these examples, separator sheet 130 is positioned between negative active material layer 116 and positive active material layer 126 and bonded to both instances of negative base side edges 151 and positive base side edges 152. Various examples of this bonding are described below. This bonding preserves the alignment of negative electrode 110 and positive electrode 120 relative to each other or, more specifically, negative active material layer 116 and positive active material layer 126. As such, lithium-metal unit cell 100 can be handled (e.g., stacking with other unit cells) without concerns that this alignment can be lost. Furthermore, negative polymer base 112 and positive polymer base 122 form outer layers in this lithium-metal unit cell 100 (shown in FIG. 1C) protecting other components of lithium-metal unit cell 100, in particular, negative active material layer 116 and positive active material layer 126.

A two-sided positive electrode can be combined with two negative electrodes (e.g., negative electrode 110 and additional negative electrode 160) as well as two separator sheets (e.g., separator sheet 130 and additional separator sheet 131) to form lithium-metal unit cell 100 as, e.g., shown in FIG. 4A. Similar to negative electrode 110, additional negative electrode 160 comprises additional negative polymer base 162 and additional negative active material layer 166 adhered to and supported on additional negative polymer base 162. Additional negative polymer base 162 comprises additional negative base side edges 153 uncovered by additional negative active material layer 156. Additional separator sheet 131 is positioned between additional negative active material layer 156 and additional positive active material layer 127 and bonded to negative base side edges 151, positive base side edges 152, and separator sheet 130. In other words, connection features 150 at the cell edges are formed by a stack of negative base side edges (top layer in FIG. 4A), separator sheet 130, positive base side edges 152 (middle layer), additional separator sheet 131, and additional negative base side edges 153 (bottom layer). Lithium-metal unit cell 100 in FIG. 4A includes twice more active material layers (both positive and negative layers) than lithium-metal unit cell 100 in FIG. 1C, while similarly maintaining the alignment of these layers in this one unit. Lithium-metal unit cell 100 in FIG. 4A also has polymer bases (more specifically, two positive polymer bases) forming outer layers.

Referring to FIG. 4B, in some examples, lithium-metal unit cell 100 comprises only one instance of polymer base 139, which reduces the total number of layers in lithium-metal unit cell 100 (in comparison to the examples in FIGS. 1C and 4A) thereby improving the volumetric capacity of lithium-metal unit cell 100. This polymer base 139 is used to support negative active material layer 116 (on one side of polymer base 139) and a combination of positive current collector 124 and positive active material layer 126 (on the other side of polymer base 139). When negative current collector 114 is used, negative current collector 114 is positioned between polymer base 139 and negative active material layer 116. This type of structure is formed by processing different sides of polymer base 139. Furthermore, polymer base 139 or, more specifically, the edges of polymer base 139 are bonded to the edges of separator sheet 130. FIG. 4B illustrates an example where the combination of positive current collector 124 and positive active material layer 126 is positioned between polymer base 139 and separator sheet 130. In another example (not shown), negative active material layer 116 is positioned between polymer base 139 and separator sheet 130.

Referring to FIGS. 4C and 4D, positive tab 128 and negative tab 118 are used to form electrical connections to lithium-metal unit cell 100. Specifically, a portion of negative active material layer 116 (or a portion of negative current collector 114, if present) extends past the boundary of positive polymer base 122, while overlapping with negative polymer base 112, thereby forming negative tab 118 as, e.g., is shown in FIGS. 2B and 2E. When negative tab 118 is formed by a portion of negative current collector 114, negative tab 118 extends past the boundary of negative active material layer 116 as, e.g., shown in FIG. 2B. Negative tab 118 forms negative tab portion 111 of negative electrode 110, while the rest of negative electrode 110 can be referred to as a negative active material portion 113.

Similarly, a portion of positive current collector 124 is uncovered by positive active material layer 126 and forms positive tab 128 as, e.g., is schematically shown in FIGS. 3B and 3E. Positive tab 128 fully overlaps with and is adhered to and supported on positive polymer base 122. Furthermore, positive tab 128 protrudes past negative polymer base 112 as, e.g., shown in FIG. 3B. When positive electrode 120 is a double-sided positive electrode as, e.g., is shown in FIG. 3D-3F, positive electrode 120 comprises two tabs, i.e., positive tab 128 and additional positive tab 129, such that positive polymer base 122 extends between these two tabs. In this example, both tabs fully overlap with and are adhered to and supported on positive polymer base 122.

It should be noted that each tab overlaps with its respective polymer base (i.e., one side is adhered to and supported by the polymer base) while the other side is exposed for making electrical connections. Furthermore, positive and negative tabs of the same lithium-metal unit cell face in opposite directions as, e.g., is schematically shown in FIGS. 4C and 4D. Using positive active material layer 126 as a reference plane, positive tab 128 and negative tab 118 extend from positive active material layer 126 in opposite directions as, e.g., is further schematically shown in FIGS. 4J and 4K.

Referring to FIGS. 4C-4D and FIGS. 4E-4I, separator sheet 130 is bonded to negative base side edges 151 (of negative polymer base 112) and positive base side edges 152 (of positive polymer base 122) using connection features 150. Various examples of connection features 150 are within the scope. It should be noted that separator sheet 130, negative polymer base 112, and positive polymer base 122 can be formed using various thermoplastic polymers that can be joined together (to form connection features 150 by plastic welding and other similar techniques. For example, FIG. 4E illustrates connection features 150 formed by welded ring-like structures with openings in the middle of these structures (e.g., formed by protruding a heated pin through a stack formed by separator sheet 130, negative polymer base 112, and positive polymer base 122). FIG. 4F illustrates connection features 150 formed by continuous linear welds (e.g., similar to heat sealing), while FIG. 4H illustrates connection features 150 formed by discontinuous (patched) linear welds. FIG. 4G illustrates connection features 150 formed by spot welds without any opening. It should be noted that discontinuous examples of connection features 150 can help electrolyte ingress into lithium-metal unit cell 100 through the edges of lithium-metal unit cell 100 (e.g., in between these discontinuous examples of connection features 150). Finally, FIG. 4I illustrates connection features 150 formed using adhesive layers, e.g., first adhesive layer 135 is positioned between separator sheet 130 and negative polymer base 112, while second adhesive layer 136 is positioned between separator sheet 130 and positive polymer base 122. Other types of connection features 150 include stitching, riveting, crimping, and the like.

Different components of lithium-metal unit cell 100 will now be described in more detail. In some examples, negative active material layer 116 has a thickness of less than 20 micrometers, less than 10 micrometers, or even less than 7 micrometers. This thickness provides enough lithium (e.g., lithium metal as active material) for the cycling of lithium-metal unit cell 100. Furthermore, any remaining lithium (at the full discharge) provides sufficient electronic conductivity to negative tab 118, e.g., when used without negative current collector 114. Negative active material layer 116 can be deposited using PVD. Another deposition example is stabilized lithium metal powder (SLMP).

Negative polymer base 112 and positive polymer base 122 provide various functions: (1) supporting respective active material layers, (2) bonding together with separator sheet 130 to form lithium-metal unit cell 100 and ensure fixed alignment in lithium-metal unit cell 100, and (3) electrical (and physical) isolation of various components. It should be noted that the bonding is performed without any risk for electrical shorts between negative electrode 110 and positive electrode 120 since negative polymer base 112 and positive polymer base 122 are electrically isolating.

In conventional cell designs, the mechanical support function (within each electrode) is provided by current collectors, e.g., copper foil in negative electrodes and aluminum foil in positive electrodes. However, metals are substantially heavier than polymers as shown in the following table comparing specific gravities of different materials.

| Material | Specific Gravity |
|---|---|
| Aluminum | 2.55-2.80 |
| Copper | 8.8-8.95 |
| Polyethylene Terephthalate (PET) | 1.34 |

As such, replacing most or all metal current collectors with polymer bases provides substantial weight savings thereby potentially increasing the gravimetric capacity of lithium-metal unit cell 100. For example, 10-micron copper foil can be replaced with a 5-20 micron PET film on negative electrode 110 without any negative current collector 114. If negative current collector 114 is needed, a 0.1-2 micron thick copper layer can be deposited onto one side of the PET film (used as negative polymer base 112).

In some examples, at least one of negative polymer base 112 and positive polymer base 122 has a thickness of less than 20 micrometers, less than 15 micrometers, or even less than 10 micrometers. At least one of negative polymer base 112 and positive polymer base 122 comprises polyimide (PI), polyethylene terephthalate (PET) and/or polyethylene terephthalate glycol (PETG). The material selecting considerations for negative polymer base 112 and positive polymer base 122 include but are not limited to the ability to deposit on the surface (e.g., coat-ability), stiffness, and thickness. Besides the weight saving, an additional benefit of using polymer bases (instead of metal foils) is safety. Specifically, polymer bases can be operable as fuses, isolating specific areas in an electrode that have experienced short circuits, while the rest of the electrode continues to function. This functionality may be referred to as localized electrode fusing. Furthermore, in lithium-metal unit cell 100 shown in FIGS. 1C and 4A, polymer bases represent the outside layers of lithium-metal unit cell 100, which makes handling lithium-metal unit cell 100 a lot easier.

In some examples, positive current collector 124 has a thickness of less than 2 micrometers, less than 1 micrometer, or even less than 0.5 micrometers. For example, a layer of aluminum can be deposited using PVD onto a 5-20 micron thick PET film (used as positive polymer base 122). In general, polyimide (PI), polyethylene terephthalate (PET) and/or polyethylene terephthalate glycol (PETG) as materials for positive polymer base 122.

FIG. 5A is a schematic cross-sectional view of multi-cell assembly 190 comprising lithium-metal unit cell 100 and multiple additional unit cells (e.g., additional lithium-metal unit cell 500). Each unit cell in multi-cell assembly 190 can have the same design. In some examples, assembly adhesive layer 510 is positioned between two adjacent cells, e.g., lithium-metal unit cell 100 and additional lithium-metal unit cell 500 shown in FIG. 5A. Assembly adhesive layer 510 can interface polymer bases of these unit cells and maintain the cell orientation in multi-cell assembly 190. In some examples (e.g., shown in FIG. 5A), separator sheet 130 can extend past the edges of each unit cell defined by negative current collector 114 and positive current collector 124 or, more specifically, by negative polymer base 112 and positive polymer base 122. In these examples, separator sheet 130 from different unit cells can form a stack and be interconnected (e.g., using various examples of separator bonding) thereby interconnecting the unit cells in multi-cell assembly 190.

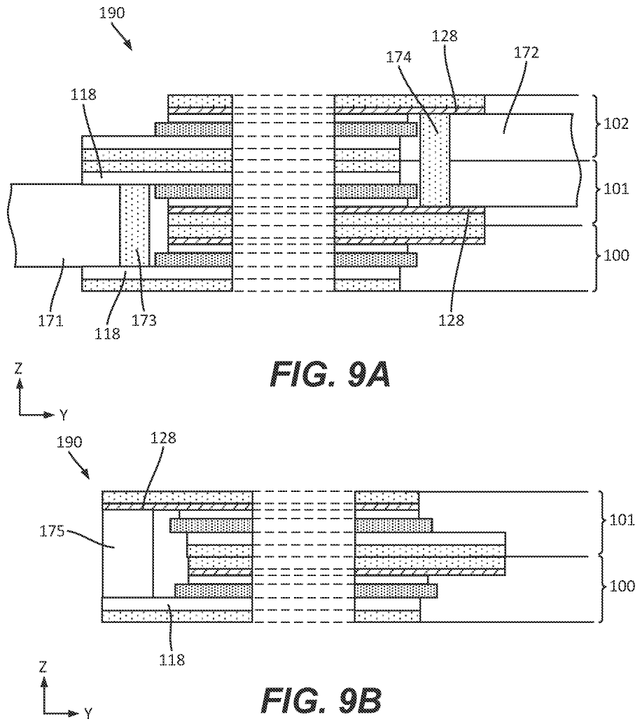

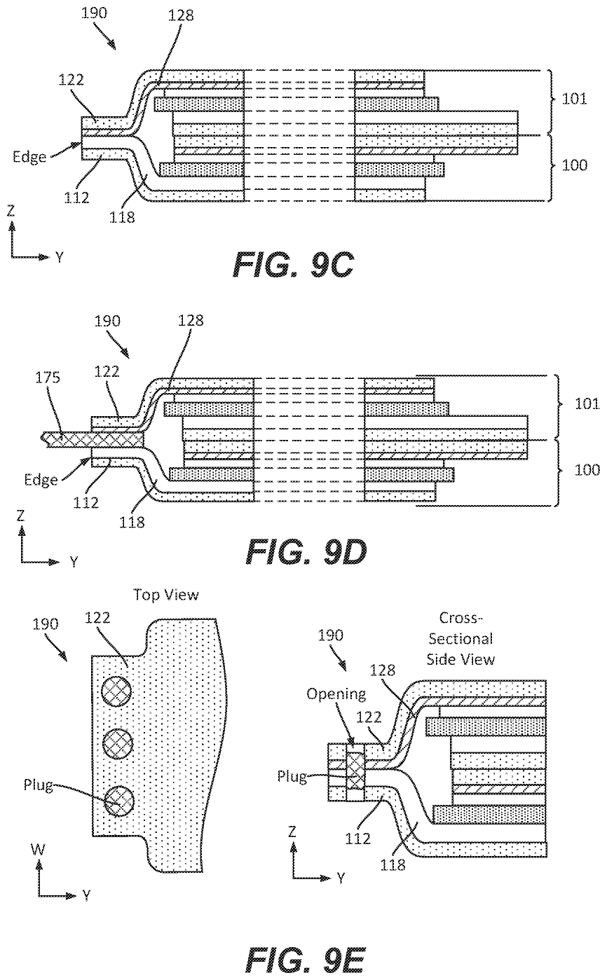

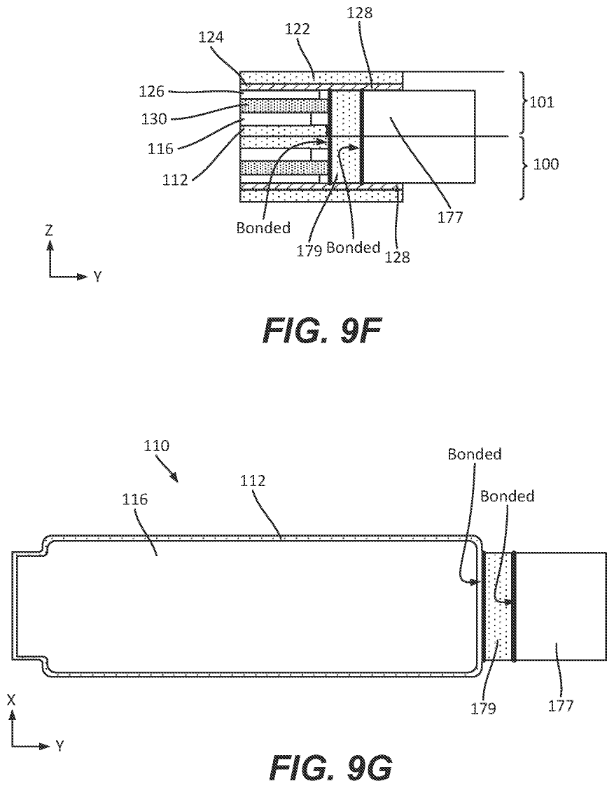

Furthermore, different unit cells in multi-cell assembly 190 can be interconnected as schematically shown in FIG. 5B and further described below with reference to FIGS. 9A-9F. For example, unit cells can be connected to negative external tab 171 and positive external tab 172. Specifically, each negative external tab 171 can be connected to negative tab 118 of each unit cell in multi-cell assembly 190. Because negative tab 118 overlaps with the respective negative polymer base, these connections are formed within polymer weld zone 193. In other words, at least some welds are performed through negative polymer bases. Similarly, each positive external tab 172 can be connected to one or more instances of positive tab 128. Because positive tab 128 overlaps with the respective positive polymer bases, these connections are also formed within polymer weld zone 193. In other words, at least some welds are performed through each positive polymer base 122 (thereby interconnecting these positive polymer bases). Negative external tab 171 is then connected to one or more of negative assembly tabs 191, which can be performed outside of polymer weld zone 193 or within no-polymer weld zone 194. Similarly, positive external tab 172 are then connected to one or more of positive assembly tabs 192, which can be performed outside of polymer weld zone 193 or within no-polymer weld zone 194. Negative assembly tabs 191 and positive assembly tabs 192 can then form or be connected to battery terminals, e.g., bus bars.

FIG. 5C is a schematic cross-sectional view of another example of multi-cell assembly 190, in accordance with some examples. Multi-cell assembly 190 comprises two or more lithium-metal unit cells, such as lithium-metal unit cell 100 and additional lithium-metal unit cell 500. These unit cells are individually supported by their own components, including connection features 150. In some examples, assembly adhesive layer 510 can be used to bond different unit cells in the same instance of multi-cell assembly 190. Furthermore, multi-cell assembly 190 comprises first assembly insulator 521 and second assembly insulator 522, at least partially enclosing all unit cells in the same instance of multi-cell assembly 190. First assembly insulator 521 and second assembly insulator 522 also define assembly edges 523. In some examples, other components of lithium-metal unit cell 100 extend to and form assembly edges 523 together with first assembly insulator 521 and second assembly insulator 522. For example, each lithium-metal unit cell 100 may have negative polymer base 112 and positive polymer base 122, forming the outer layers of these cells and extending to form assembly edges 523. It should be noted that negative polymer base 112 and positive polymer base 122 of each lithium-metal unit cell 100 can be separately interconnected by the connection features 150 at the cell level. Furthermore, first assembly insulator 521 and second assembly insulator 522 (in addition to any cell components extending to assembly edges 523) can be interconnected by assembly connection features 530. Assembly connection features 530 can be similar to connection features 150, various examples of which are described above with reference to FIGS. 4E-4H.

In some examples, multi-cell assembly 190 comprises liquid electrolyte, which provide ionic conductivity between the negative electrode 110 and positive electrode 120 or, more specifically, between negative active material layer 116 and positive active material layer 126. In these examples, multi-cell assembly 190 may be referred to as a lithium-metal liquid-electrolyte (LiMLE) electrochemical cell. Liquid electrolyte should be distinguished from solid and gel electrolytes used in other types of lithium-metal cells. Liquid electrolyte should be distinguished from gel electrolytes, in which polymer matrices are used to retain salts and solvents. Liquid electrolyte described herein are free from polymer components such as polyacrylonitrile (PAN), polymethylmethacrylate (PMMA), polyvinylchloride (PVC), and polyvinylidene fluoride (PVDF) and have a viscosity of less than 1,000 cP, less than 500 cP, or less than 200 cP at the room temperature.

Some examples of liquid electrolyte include, but are not limited to, a mixture of one or more lithium-containing salts and one or more liquid solvents. Some examples of lithium-containing salts include, but are not limited to, lithium bis(fluorosulfonyl)imide (LiFSI), lithium bis(trifluoromethylsulfonyl)amide (LiTFSI), lithium tetrafluoroborate (LiBF₄), lithium hexafluorophosphate (LiPF₆), lithium bis(oxalato)borate (LiBOB), lithium difluoro(oxalato)borate (LiDFOB), lithium trifluoromethanesulfonate (LiTf), lithium nitrate (LiNO₃), and various combinations thereof. In some examples, lithium-containing salts are LiFSI or LiTFSI, e.g., preferably LiFSI. Lithium-containing salts are configured to dissociate into lithium ions and anions. In some examples, the concentration of lithium-containing salts in liquid electrolyte is between 10 mol % and 50 mol % or, more specifically, between 20 mol % and 40 mol %.

Some examples of liquid solvents but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl) ether (G2), triethylene glycol dimethyl ether (G3), or tetraethylene glycol dimethyl ether (G4), Bis(2,2,2-trifluoroethyl)ether (BTFE), ethylal, 1,1,2,2-tetrafluoroethyl 2,2,3,3-tetrafluoropropyl ether (TFPE)), and a combination thereof. In some examples, the concentration of liquid solvents in liquid electrolyte is between 0 mol % and 60 mol % or, more specifically, between 5 mol % and 50 mol % or even between 10 mol % and 40 mol %. A specific category of liquid solvents is fluoroether diluents, e.g., bis(2,2,2-trifluoroethyl)ether (BTFE), ethylal, and 1,1,2,2-tetrafluoroethyl 2,2,3,3-tetrafluoropropyl ether (TFPE)), 0-60 mol %. More molecules could be added here.

Liquid electrolyte can comprises various additives, e.g., metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate)borate (BOB) anions), ionic liquids (e.g., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

In some examples, liquid electrolyte comprises ionic liquids in addition to or instead of additives. Some examples of ionic liquids include, but are not limited to, 1-allyl-3-methylimidazolium bis(trifluoromethanesulfonyl)imide (AMIm)TFSI and 1-methyl-3-propylimidazolium bis(trifluoromethanesulfonyl)imide (Im₁₃TFSI, or Im₁₃TFSI—SiO₂), n-methyl-n-propylpiperidinium bis(trifluoromethanesulfonyl)imide (Pip₁₃TFSI or Pip₁₃TFSI—SiO₂), n-propyl-n-methylpyrrolidinium bis(fluoromethanesulfonyl)imide (PYR₁₃FSI), n-butyl-n-methylpyrrolidinium bis(fluorosulfonyl) imide (PYR14FSI), tri-methylhexyl ammonium bis-(trifluorosulfonyl) imide (TMHATFSI), butyl-trimethyl ammonium bis(trifluoromethanesulfonyl)imide (QATFSI), 3-(2-(2-methoxy ethoxy)ethyl)-1-methylimidazolium TFSI (IMo_{1,10201}TFSI) and 1-(2-methoxyethyl)-3-methylimidazolium TFSI (IMI_{1,2O1}TFSI). In some examples, the concentration of the ionic liquids in liquid electrolyte is between 0 mol % and 40 mol % or, more specifically, between 5 mol % and 35 mol %, or even between 10 mol % and 30 mol %.

In some examples, liquid electrolyte can have a viscosity of at least 15 cP or, more specifically, at least 25 cP, at least 50 cP, or even at least 100 cP at room temperature. For example, liquid electrolyte can have a viscosity of 15-500 cP or, more specifically, 20-300 cP or, more specifically, 40-200 cP at room temperature. High viscosity can be driven by specific components needed in liquid electrolyte to enable the functioning of liquid electrolyte in LiMLE electrochemical cell 100. It should be noted that the viscosity changes with temperature. In fact, this characteristic is used to enable the controlled deposition of lithium metal during fast charging (e.g., a charge rate of at least 0.8C or even at least 1C). The viscosity determined the ionic diffusivity (lithium ions) within liquid electrolyte. In some examples, liquid electrolyte can have an ionic diffusivity of between 1E-13 m²/sec-1E-10 m²/sec or, more specifically, 5E-12 m²/sec-5E-10 m²/sec or, even more specifically, 1E-12 m²/sec-1E-11 m²/sec at room temperature.

### Method Examples of Fabricating Lithium-Metal Unit Cells

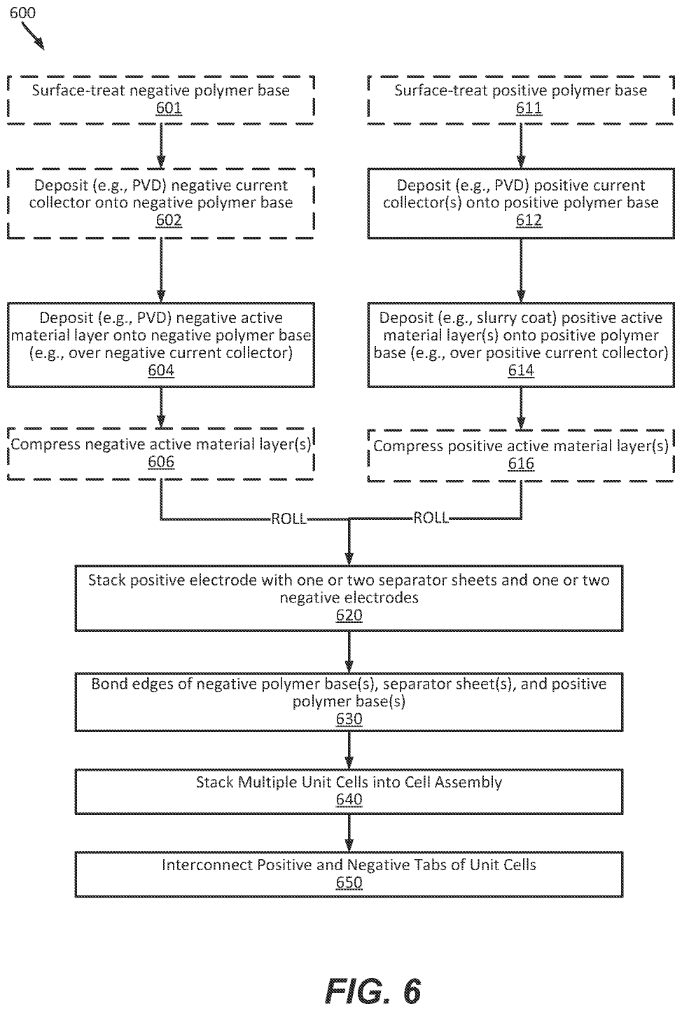

FIG. 6 is a process flowchart corresponding to method 600 of fabricating lithium-metal unit cell 100, in accordance with some examples. Various examples of lithium-metal unit cell 100 are described above. At a high level, method 600 comprises fabricating negative electrode 110 (blocks 601-606), fabricating positive electrode 120 (blocks 611-616), fabricating lithium-metal unit cell 100 (blocks 620-630), and using lithium-metal unit cells to fabricate multi-cell assembly 190 (blocks 640-650).

In some examples, method 600 comprises (optionally) surface treating (block 601) negative polymer base 112. For example, negative polymer base 112 can be plasma treated to improve the adhesion of layer deposited layers.

In some examples, method 600 comprises (optionally) depositing (block 602) negative current collector 114 onto negative polymer base 112. For example, a copper layer can be deposited onto negative polymer base 112 using PVD.

In some examples, method 600 comprises depositing (block 604) negative active material layer 116 onto negative polymer base 112, e.g., on the surface of negative current collector 114, if present, or on the surface of negative polymer base 112, if negative current collector 114 is not present. Negative active material layer 116 can comprise lithium metal and can be deposited using PVD.

In some examples, method 600 comprises (optionally) compressing (block 606) negative active material layer 116, e.g., to reduce the porosity of negative active material layer 116.

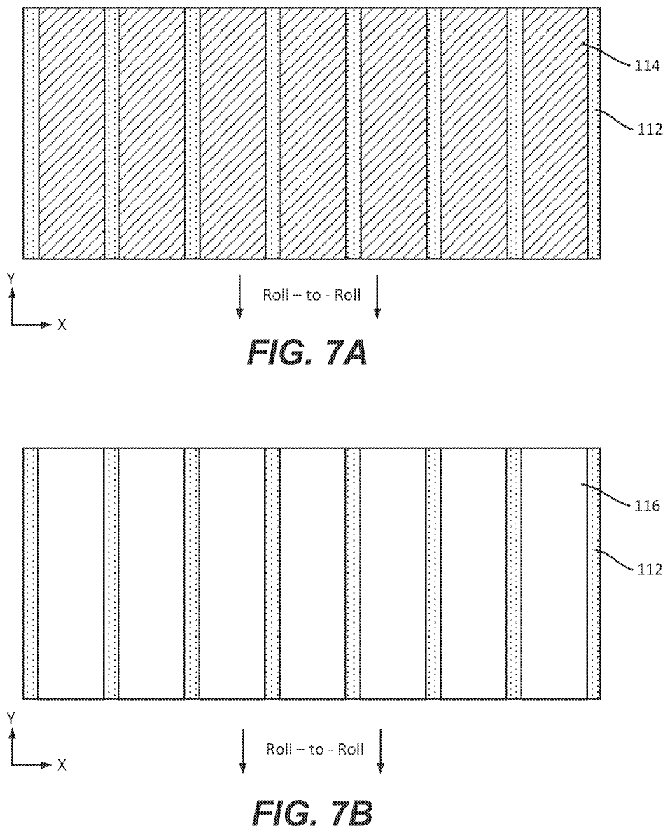

At this stage, negative electrode 110 can be provided on a roll and at least partially integrated (e.g., by sharing negative polymer base 112) with other negative electrodes as, e.g., is schematically shown in FIGS. 7A-7B. Negative electrode 110 can be separated from this roll while stacking with positive electrode 120 as further described below.

In some examples, method 600 comprises (optionally) surface treating (block 611) positive polymer base 122. For example, positive polymer base 122 can be plasma treated to improve the adhesion of later deposited layers.

In some examples, method 600 comprises depositing (block 612) positive current collector 124 onto positive polymer base 122. For example, an aluminum layer can be deposited using PVD.

In some examples, method 600 comprises depositing (block 614) positive active material layer 126 onto positive polymer base 122 (e.g., on the surface of positive current collector 124). For example, positive active material layer 126 can be deposited using the slot-die coating. Positive active material structures, polymer binders, and other components can be mixed into a slurry and the slurry is then coated on the surface of positive current collector 124 and dried to form positive active material layer 126.

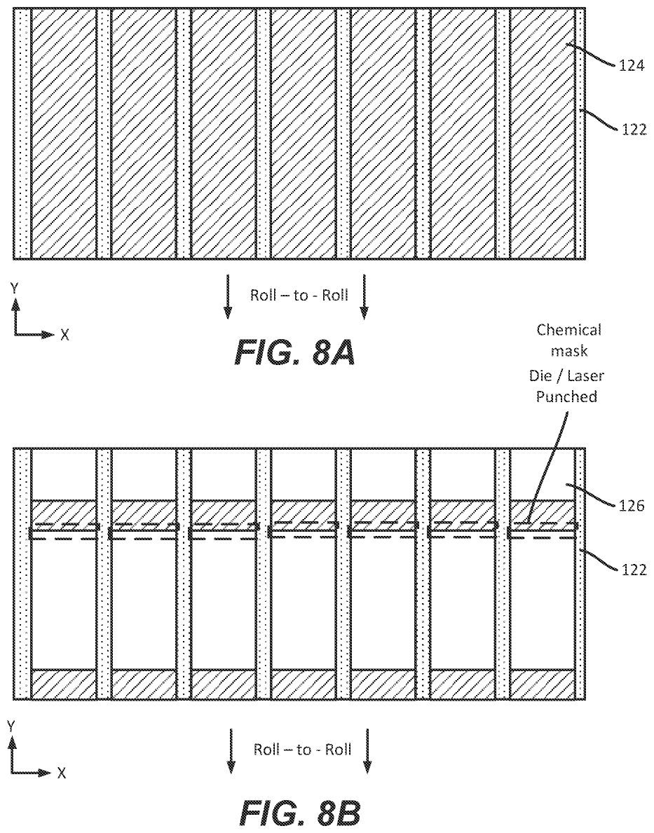

In some examples, method 600 comprises (optionally) compressing (block 616) positive active material layer 126. At this stage, positive electrode 120 can be provided on a roll and at least partially integrated (e.g., by sharing positive polymer base 122) with other positive electrodes as, e.g., is schematically shown in FIGS. 8A-8B. Positive electrode 120 can be separated from this roll while stacking with negative electrode 110 as further described below.

In some examples, method 600 comprises stacking (block 620) negative electrode 110, positive electrode 120, and separator sheet 130 positioned between negative electrode 110 and positive electrode 120. For example, negative electrode 110, positive electrode 120, and separator sheet 130 are provided on rolls (e.g., fed from different directions to a stacker). A stacker-bonder removes these components from their respective rolls and forms a stack that (once bonded) becomes lithium-metal unit cell 100.

In some examples, method 600 comprises bonding (block 630) negative base side edges 151, positive base side edges 152, and separator sheet 130 as, e.g., is shown in FIGS. 1C and 4A. Various bonding options were discussed above with reference to FIGS. 4E-4I. At this point, lithium-metal unit cell 100 is fabricated.

In some examples, method 600 comprises stacking (block 640) multiple lithium-metal unit cells as, e.g., is schematically shown in FIG. 5. For example, multiple lithium-metal unit cells can be used together to increase the voltage and/or current ratings of a stack of these cells (relative to each individual cell).

In some examples, method 600 comprises interconnecting (block 650) multiple lithium-metal unit cells as, e.g., is schematically shown in FIGS. 9A-9F. Various types of connections are shown. For example, FIG. 9A illustrates three lithium-metal unit cells interconnected in parallel. Specifically, negative tab 118 of lithium-metal unit cell 100 is connected to negative tab 118 of unit cell 101 using negative external tab 171. It should be noted that when connections between the negative tab 118 and negative external tab 171 are formed, negative tab 118 overlaps with their respective negative polymer bases. Similarly, positive tab 128 of unit cell 101 is connected to positive tab 128 of unit cell 102 using positive external tab 172. Positive tab 128 also overlaps with the respective positive polymer base. As such, welding or other types of connections are performed through polymer bases, which can be referred to as polymer weld zones or, more generally, polymer connection zones. Various forms of connection techniques (e.g., laser welding) are capable of forming such connections. It should be noted that negative external tab 171 and positive external tab 172 can extend outside of the respective unit cells and form other electrical connections, e.g., as described above with reference to FIG. 5B.

Referring to FIG. 9A, in some examples, negative external tab 171 is separated from lithium-metal unit cell 100 and unit cell 101 by negative external insulator 173, which prevents direct contact and shorts between negative external tab 171 and the positive electrodes of lithium-metal unit cell 100 and unit cell 101. Similarly, positive external tab 172 is separated from unit cell 101 and unit cell 102 by positive external insulator 174, which prevents direct contact and shorts between positive external tab 172 and the negative electrodes of lithium-metal unit cell 100 and unit

FIG. 9B illustrates an example of two cells interconnected in series. Specifically, negative tab 118 of lithium-metal unit cell 100 is connected to positive tab 128 of unit cell 101 using negative-positive connector 175. While an external insulator is not shown in FIG. 9B, in some examples, negative-positive connector 175 is separated from other electrodes of lithium-metal unit cell 100 and unit cell 101 by an external insulator. Furthermore, negative-positive connector 175 does not extend past the boundaries of lithium-metal unit cell 100 and unit cell 101 in FIG. 9B. In some examples, shown in FIG. 9D, negative-positive connector 175 extends past these boundaries to form additional connections and effectively operates similarly to tabs described above with reference to FIG. 5B.

FIG. 9C illustrates an example of two cells interconnected in series without any additional connectors (such as negative-positive connector 175 in FIG. 9B). Specifically, negative tab 118 of lithium-metal unit cell 100 directly interfaces and connected to positive tab 128 of unit cell 101. Negative tab 118 and positive tab 128 as well as negative polymer base 112 and positive polymer base 122 can be sufficiently flexible to compensate for the thickness of other components disposed between negative tab 118 and positive tab 128. Furthermore, FIG. 9C illustrates the edge of negative tab 118 and positive tab 128 being exposed. In some examples, negative polymer base 112 and positive polymer base 122 protrude past these tab edges and seal these tab edges from the environment, e.g., to prevent electric shocks.

FIG. 9E illustrates an example of negative tab 118 of lithium-metal unit cell 100 directly interfaces being connected to positive tab 128 of unit cell 101 using plugs (e.g., solder plugs) filled into openings formed within these tabs and their respective polymer basis. In some examples (not shown in the drawings), the plugs extend to the surface of one or both polymer basis and even outside of the opening to form electrical connections to these plugs. Alternatively, in some examples (not shown in the drawings), the plugs are sealed inside the openings by insulating material.

In some examples, tabs and/or connectors can be integrated into electrodes, e.g., to simplify the handling of various components. For example, FIGS. 9F and 9G illustrate negative electrode 110 comprising a negative spacer 177, which is used for connecting positive tab 128 of lithium-metal unit cell 100 and positive tab 128 of unit cell 102. Negative spacer 177 can be bonded to spacer insulator 179, which in turn is bonded to negative polymer base 112. In some examples, spacer insulator 179 is formed by negative polymer base 112 (e.g., by specifically shaping negative polymer base 112 to extend past the boundaries of negative active material layer 116. It should be noted that in this example, negative spacer 177 is a part of negative electrode 110 and is isolated from negative active material layer 116.

It should be noted that various connection examples, which are described above with reference to FIGS. 9A-9G, can be used for different unit cells or within the same unit cell comprising a double-sided positive electrode, which is described above with reference to FIG. 4A.

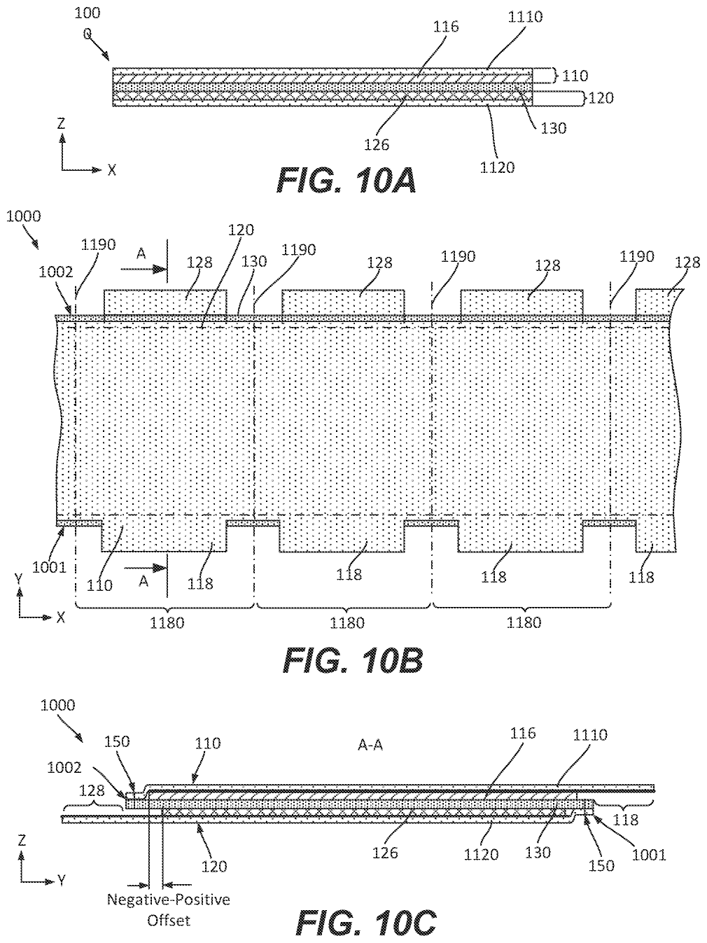

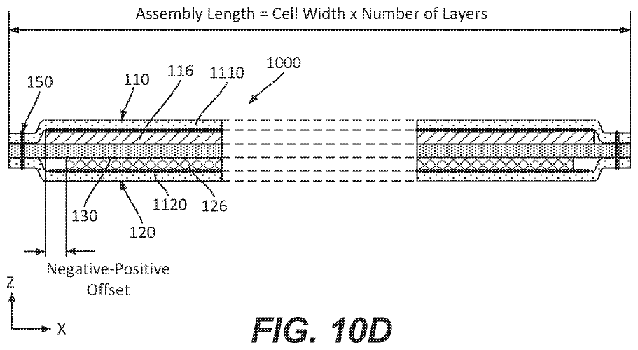

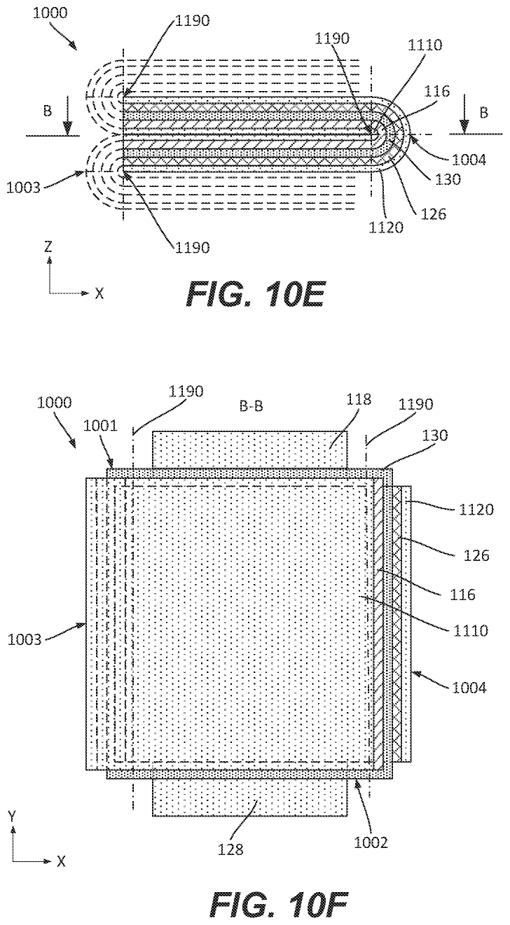

FIGS. 10A-10F illustrate additional examples of an electrode assembly that is formed by stacking two continuous electrodes (i.e., a positive electrode and a negative electrode) and a separator and then folding this stack to form a lithium-metal unit cell, which may be referred to continuous cell assembly 1000 due to the continuous nature of the electrodes forming this cell assembly. Specifically, FIG. 10A illustrates a cross-sectional view of continuous cell assembly 1000 comprising negative electrode 110, positive electrode 120, and separator sheet 130 positioned between negative electrode 110 and positive electrode 120. In some examples, negative electrode 110 comprises negative substrate 1110 and negative active material layer 116. Alternatively, negative electrode 110 is formed entirely from negative active material layer 116 (e.g., lithium foil) and does not include any negative substrates. When negative substrate 1110 is present, negative substrate 1110 can be a monolithic structure (e.g., metal foil) or a layered structure comprising, e.g., negative polymer base 112 and negative current collector 114. Furthermore, when negative substrate 1110 is present, negative active material layer 116 is positioned only on one side of negative substrate 1110 (i.e., the side facing separator sheet 130 and positive electrode 120). The other side of negative substrate 1110 can be exposed.

In some examples, positive electrode 120 comprises positive substrate 1120 and positive active material layer 126. Positive substrate 1120 can be a monolithic structure (e.g., metal foil) or a layered structure comprising, e.g., positive polymer base 122 and positive current collector 124. Positive active material layer 126 is positioned only on one side of positive substrate 1120 (i.e., the side facing separator sheet 130 and negative electrode 110). The other side of positive substrate 1120 can be exposed.

FIG. 10B illustrates a top view of continuous cell assembly 1000, in accordance with some examples. A portion of negative substrate 1110 extends past first edge 1001 of the stack forming negative tab 118. Similarly, a portion of positive substrate 1120 extends past second edge 1002 of the stack forming positive tab 128. First edge 1001 and second edge 1002 are defined by the edges of separator sheet 130. Additional details of first edge 1001, second edge 1002, separator sheet 130, negative tab 118, and positive tab 128 can be seen in FIG. 10C, which is a cross-sectional view of continuous cell assembly 1000, identified as A-A in FIG. 10B. While FIGS. 10B and 10C illustrate an example where negative tab 118 and positive tab 128 extend in opposite directions, an example where negative tab 118 and positive tab 128 extend in the same direction (e.g., side by side) is also within the scope.

FIG. 10B also illustrates multiple instances of fold axis 1190, which define stackable units 1180 of continuous cell assembly 1000. Once continuous cell assembly 1000 is folded, these stackable units 1180 form a stack in the Z direction as described below with reference to FIGS. 10E and 10F. It should be noted that at least one portion of negative electrode 110 (e.g., negative substrate 1110, if present, or negative active material layer 116, if negative substrate 1110 is not present) is continuous and monolithic across all stackable units 1180. Similarly, positive substrate 1120 is continuous and monolithic across all stackable units 1180. Finally, separator sheet 130 is continuous and monolithic across all stackable units 1180.

FIG. 10C illustrates a cross-section view of a portion of continuous cell assembly 1000, in accordance with some examples. This portion includes both tabs (i.e., negative tab 118 and positive tab 128) extending in opposite directions. Furthermore, FIG. 10C illustrates an example where each negative substrate 1110 and positive substrate 1120 is connected to separator sheet 130. For example, negative substrate 1110 can comprise negative polymer base 112 and negative current collector 114. Negative current collector 114 interfaces negative active material layer 116. Negative polymer base 112 can extend past negative current collector 114 to second edge 1002 and is connected to separator sheet 130, e.g., using connection features 150. Various examples of connection features 150 are described above with reference to FIGS. 4E-4H. Similarly, positive substrate 1120 can comprise positive polymer base 122 and positive current collector 124. Positive current collector 124 interfaces positive active material layer 126. Positive polymer base 122 can extend past positive current collector 124 to first edge 1001 and is connected to separator sheet 130, e.g., using connection features 150.

Referring to FIG. 10C, when negative substrate 1110 comprises negative polymer base 112 and negative current collector 114, both polymer bases (i.e., negative polymer base 112 and negative current collector 114) extend past first edge 1001 to form negative tab 118. Similarly, when positive substrate 1120 comprises positive polymer base 122 and positive current collector 124, positive polymer base 122 and positive current collector 124 extend past second edge 1002 to form positive tab 128.

In addition to connection features 150 along first edge 1001 and second edge 1002, similar examples of connection features 150 can be used on the end edges of continuous cell assembly 1000, e.g., as shown in FIG. 10D. Specifically, these end edges extend perpendicular to first edge 1001 and second edge 1002 and are parts of the first and last ones of stackable units 1180. After folding, these stackable units 1180 form the top and bottom of the stack.

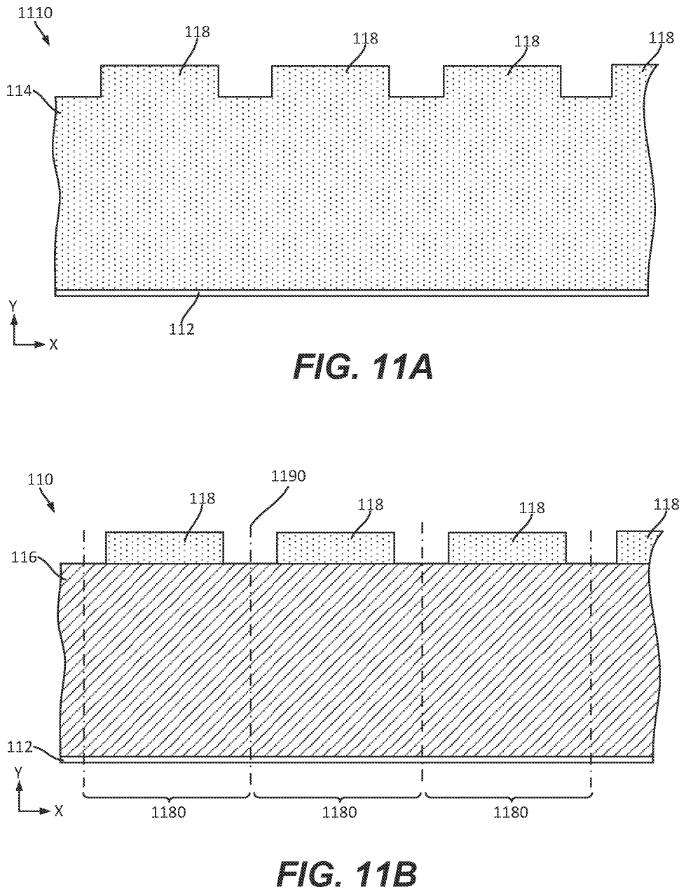

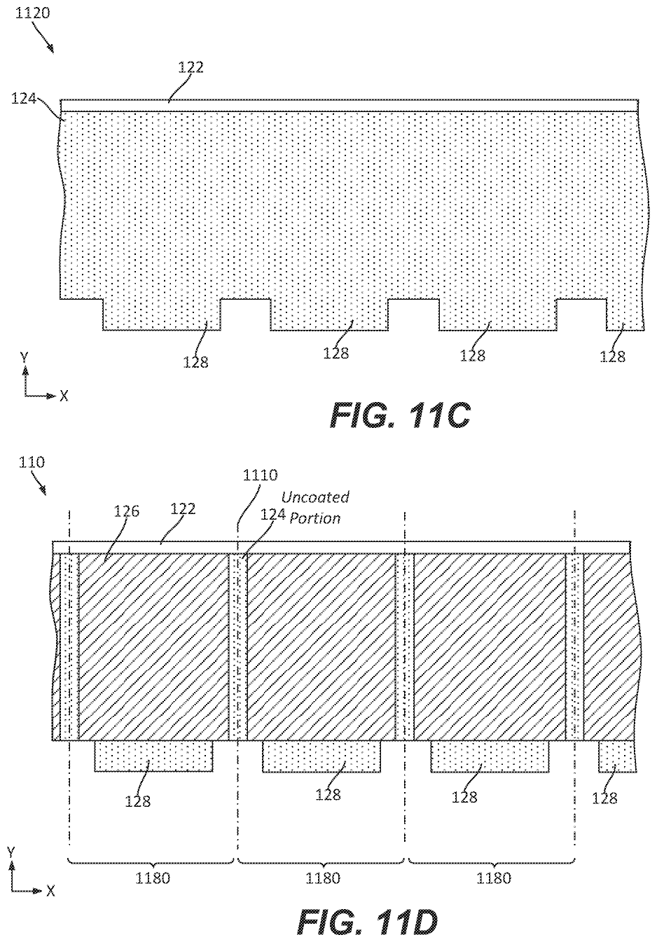

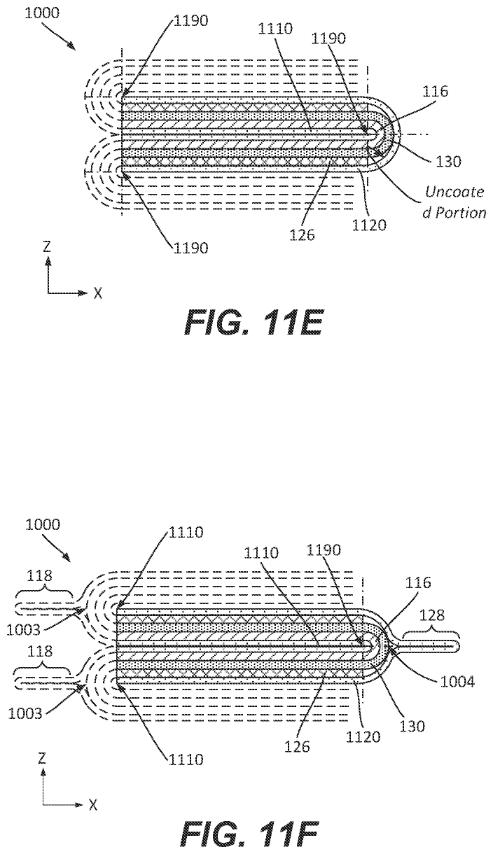

FIG. 10E illustrates a side cross-section view of a portion of continuous cell assembly 1000 after its folding, in accordance with some examples. Specifically, continuous cell assembly 1000 is folded around fold axis 1190, three of which are shown in FIG. 10E. Referring to the left instance of fold axis 1190 in FIG. 10E, negative electrode 110 or, more specifically, negative substrate 1110 forms the inner-most layer of this specific fold. To the left from this fold axis 1190, negative substrate 1110 forms a stack contacting itself. When negative substrate 1110 is not used negative active material layer 116 forms the inner-most layer of this specific fold. Otherwise, negative active material layer 116 form the next layer in this specific fold. It should be noted that unlike, positive active material layer 126, negative active material layer 116 does not need to have a break/gap as additional negative active material in the folded area is not detrimental to the performance (e.g., safety) of continuous cell assembly 1000. These breaks/gaps in positive active material layer 126 are further described below with reference to FIG. 11D. However, in some examples, negative active material layer 116 can be also patterned and have break/gaps in the folded areas. It should be noted that at least one component of each negative electrode 110 and positive electrode 120 extends through each folded area.

Referring to FIG. 10E, separator sheet 130 also extends through the folded area. The next layer, which extends through the folded area, is positive active material layer 126. However, in some examples (described below with reference to FIGS. 11D, 11E, and 11F) positive active material layer 126 is patterned (non-continuous) and does not extend through the folded areas. Finally, positive substrate 1120 extends through the folded area and forms an outer layer of this particular fold. It should be noted that positive substrate 1120 is exposed at this edge and can be used to form electrical connections, in addition to or instead of positive tab 128.

While the two folded areas on the left are schematically shown with dotted lines, one having ordinary skill in the art would appreciate that the position of different layers is reversed to that of the right folded area described above. Specifically, in these folded areas on the left, positive substrate 1120 is the innermost layer, forming a stack contacting itself. Negative substrate 1110 is the outermost layer that is exposed at this edge and can be used to form electrical connections, in addition to or instead of negative tab 118.

FIG. 10F illustrates the top cross-section view of continuous cell assembly 1000 in FIG. 10E, in accordance with some examples. The cross-section is identified as B-B in FIG. 10E. Specifically, the offset of different layers between first edge 1001 and second edge 1002 is illustrated in FIG. 10F.

FIG. 11A-11D illustrate stages and subassemblies used for the fabrication of negative electrode 110 and positive electrode 120, in accordance with some examples. Specifically, FIG. 11A illustrates a top planar view of negative substrate 1110. Negative substrate 1110 is patterned specifically to form negative tab 118. In some examples, each negative tab 118 corresponds to one of stackable units 1180. Alternatively, some of stackable units 1180 do not have negative tab 118 since the connection is provided through the continuity of negative substrate 1110. In this example, negative substrate 1110 also comprises negative polymer base 112 and negative current collector 114, positioned on negative polymer base 112 and supported by negative polymer base 112. In some examples, negative polymer base 112 extends past negative current collector 114 in the direction opposite of negative tab 118, thereby forming a polymer base edge. In some examples, this polymer base edge is continuous along the entire length (in the X direction) of negative electrode 110. Furthermore, in some examples (not shown), a polymer base edge can extend in between negative tab 118, along the primary portion of negative electrode 110. It should be noted that negative current collector 114 extends to negative tab 118.

FIG. 11B illustrates a top planar view of negative electrode 110, comprising negative substrate 1110 (shown in FIG. 11A) and negative active material layer 116, added to and supported by negative substrate 1110. Negative tab 118 and the polymer base edge remain uncoated (i.e., free from negative active material layer 116). In some examples (shown), negative active material layer 116 forms a continuous layer spanning multiple instances of stackable units 1180. Alternatively (not shown), negative active material layer 116 is patterned and has gaps around fold axis 1190 (similar to positive electrode 120 shown in FIG. 11D).

FIG. 11C illustrates a top planar view of positive substrate 1120. Positive substrate 1120 is patterned specifically to form positive tab 128. In some examples, each positive tab 128 corresponds to one of stackable units 1180. Alternatively, some of stackable units 1180 do not have positive tab 128 since the connection is provided through the continuity of positive substrate 1120. In this example, positive substrate 1120 also comprises positive polymer base 122 and positive current collector 124, positioned on positive polymer base 122 and supported by positive polymer base 122. In some examples, positive polymer base 122 extends past positive current collector 124 in the direction opposite of positive tab 128, thereby forming a polymer base edge. In some examples, this polymer base edge is continuous along the entire length (in the X direction) of positive electrode 120. Furthermore, in some examples (not shown), a polymer base edge can extend in between positive tab 128, along the primary portion of positive electrode 120. It should be noted that positive current collector 124 extends to positive tab 128.

FIG. 11D illustrates a top planar view of positive electrode 120, comprising positive substrate 1120 (shown in FIG. 11C) and positive active material layer 126, added to and supported by positive substrate 1120. Positive tab 128 and the polymer base edge remain uncoated (i.e., free from positive active material layer 126). In some examples (shown), positive active material layer 126 is patterned and has gaps around fold axis 1190. The width of the gap depends on the thicknesses of other components, corresponding to the turning radiuses in the folded area. Alternatively, positive active material layer 126 is continuous, e.g., as shown above in FIG. 10E.

FIG. 11E illustrates continuous cell assembly 1000 in a folded state. Unlike the example in FIG. 10E, the example in FIG. 11E has positive electrode 120 that is patterned with no positive active material layer in the folded area (identified as an “uncoated portion”). This type of positive electrode 120 is shown and described above with reference FIG. 11D. One benefit of using the patterned positive electrode is not to create an excess of the positive active material in the folded area. It should be noted that excess of the negative active material is generally not an issue.

As noted above, folded areas have exposed negative substrate 1110 and positive substrate 1120 on the opposite sides of the stack. In some examples, portions of negative substrate 1110 are extended past third edge 1003 to form negative tab 118, e.g., as schematically shown in FIG. 11F. Similarly, portions of positive substrate 1120 are extended past fourth edge 1004 to form positive tab 128, e.g., as schematically shown in FIG. 11F. It should be noted that third edge 1003 and fourth edge 1004 extend perpendicular to first edge 1001 and second edge 1002 shown in other drawings. Negative tab 118 extending from third edge 1003 can be in addition to or instead of negative tab 118 extending from first edge 1001. Similarly, positive tab 128 extending from fourth edge 1004 can be in addition to or instead of positive tab 128 extending from second edge 1002.

These negative tab 118 extending from third edge 1003 and positive tab 128 extending from fourth edge 1004 can be formed by patterning corresponding electrodes and extending the width of uncoated gaps. For example, the length of these tabs can be about half the gap width (due to the folding).

### Application Examples

Lithium-metal unit cell 100, described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles).

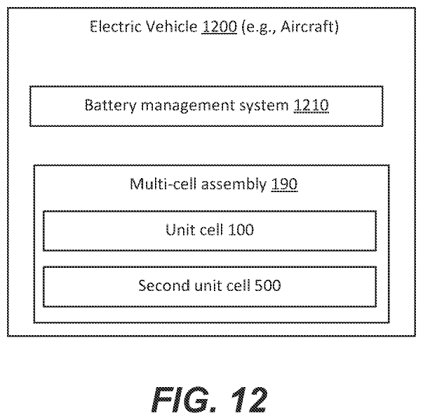

FIG. 12 is a block diagram of electric vehicle 1200 (e.g., aircraft) comprising a multi-cell assembly 190, which in turn comprises one or more lithium-metal unit cells. Electric vehicle 1200 also comprises battery management system 1210, electrically and communicatively coupled to multi-cell assembly 190. For example, multi-cell assembly 190 can receive various operating signals from multi-cell assembly 190, such as state of charge, temperature, voltage, current, and the like.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

What is claimed is:

1. A lithium-metal unit cell comprising:
a negative electrode, comprising
a negative polymer base and
a negative active material layer adhered to and supported on the negative polymer base and comprising lithium metal,
wherein the negative polymer base comprises negative base side edges uncovered by the negative active material layer;
a positive electrode comprising
a positive polymer base,
a positive current collector adhered to and supported on the positive polymer base, and
a positive active material layer adhered to and supported on the positive polymer base such that the positive current collector is positioned between the positive polymer base and the positive active material layer,
wherein the positive polymer base comprises positive base side edges uncovered by the positive active material layer; and
a separator sheet, positioned between the negative active material layer and the positive active material layer and bonded to the negative base side edges and the positive base side edges.

2. The lithium-metal unit cell of claim 1, wherein the negative electrode further comprises a negative current collector adhered to and supported on the negative polymer base such that the negative current collector is positioned between the negative polymer base and the negative active material layer.

3. The lithium-metal unit cell of claim 1, wherein the negative active material layer directly interfaces and adheres to the negative polymer base.

4. The lithium-metal unit cell of claim 1, further comprising:
an additional negative electrode, comprising
an additional negative polymer base and
an additional negative active material layer adhered to and supported on the additional negative polymer base,
wherein the additional negative polymer base comprises additional negative base side edges uncovered by the additional negative active material layer; and
an additional separator sheet, wherein:
the positive electrode further comprises an additional positive current collector adhered to and supported on the positive polymer base such that the positive polymer base is positioned between the positive current collector and the additional positive current collector,
the positive electrode further comprises an additional positive active material layer adhered to and supported on the positive polymer base such that the additional positive current collector is positioned between the positive polymer base and the additional positive active material layer, and
the additional separator sheet is positioned between the additional negative active material layer and the additional positive active material layer and bonded to the negative base side edges, the positive base side edges, and the separator sheet.

5. The lithium-metal unit cell of claim 1, wherein:
a portion of the positive current collector is uncovered by the positive active material layer and forms a positive tab, and
the positive tab fully overlaps with and is adhered to and supported on the positive polymer base.

6. The lithium-metal unit cell of claim 5, wherein:
a portion of the negative active material layer, extending past a boundary of the positive polymer base forms a negative tab,
the positive tab extends past a boundary of the negative polymer base, and
the positive tab and the negative tab extend from the positive active material layer in opposite directions.

7. The lithium-metal unit cell of claim 1, wherein the negative active material layer has a thickness of less than 10 micrometers.

8. The lithium-metal unit cell of claim 1, wherein the positive current collector has a thickness of less than 1 micrometer.

9. The lithium-metal unit cell of claim 1, wherein the negative polymer base has a thickness of less than 15 micrometers.

10. The lithium-metal unit cell of claim 1, wherein the positive polymer base has a thickness of less than 15 micrometers.

11. The lithium-metal unit cell of claim 1, wherein at least one of the negative polymer base and the positive polymer base comprises a polymer selected from the group consisting of polyimide (PI), polyethylene terephthalate (PET) and polyethylene terephthalate glycol (PETG).

12. The lithium-metal unit cell of claim 1, wherein the separator sheet is bonded to the negative base side edges and the positive base side edges using heat bonding.

13. The lithium-metal unit cell of claim 1, wherein the separator sheet is bonded to the negative base side edges and the positive base side edges using mechanical stitching.

14. A multi-cell assembly comprising:
a unit lithium-metal cell and an additional lithium-metal unit cell, each comprising
a negative electrode, comprising
a negative polymer base and
a negative active material layer adhered to and supported on the negative polymer base and comprising lithium metal,
wherein the negative polymer base comprises negative base side edges uncovered by the negative active material layer;
a positive electrode comprising
a positive polymer base,
a positive current collector adhered to and supported on the positive polymer base, and
a positive active material layer adhered to and supported on the positive polymer base such that the positive current collector is positioned between the positive polymer base and the positive active material layer,
wherein the positive polymer base comprises positive base side edges uncovered by the positive active material layer; and
a separator sheet, positioned between the negative active material layer and the positive active material layer and bonded to the negative base side edges and the positive base side edges,
wherein the negative polymer base or the positive polymer base of the unit cell directly interfaces the additional lithium-metal unit cell.

15. The multi-cell assembly of claim 14, wherein the separator sheet of the unit cell and the separator sheet of the additional lithium-metal unit cell are stacked, directly interface with each other, and interconnected thereby supporting the lithium-metal unit cell and the additional lithium-metal unit cell relative to each other.

16. The multi-cell assembly of claim 14, further comprising a first assembly insulator and a second assembly insulator attached to each other around edges of the lithium-metal unit cell and the additional lithium-metal unit cell and at least partially enclosing the lithium-metal unit cell and the additional lithium-metal unit cell and define assembly edges.

17. The multi-cell assembly of claim 16, wherein the negative polymer base and the positive polymer base of each of the lithium-metal unit cell and the additional lithium-metal unit cell are positioned away from the assembly edges.

18. The multi-cell assembly of claim 16, wherein the negative polymer base and the positive polymer base of each of the lithium-metal unit cell and the additional lithium-metal unit cell extend to the assembly edges and stacked together with the first assembly insulator and the second assembly insulator, collectively forming the assembly edges.

19. The multi-cell assembly of claim 14, further comprising a liquid electrolyte such that the multi-cell assembly is a lithium-metal liquid-electrolyte electrochemical cell.

20. A method of fabricating a lithium-metal unit cell, the method comprising:
depositing a negative active material layer over a negative polymer base, wherein the negative polymer base comprises negative base side edges uncovered by the negative active material layer, thereby forming a negative electrode;
depositing a positive current collector over a positive polymer base, wherein the positive polymer base comprises positive base side edges uncovered by the positive current collector;
depositing a positive active material layer over the positive current collector such that the positive current collector is positioned between the positive polymer base and the positive active material layer, thereby forming a positive electrode;
stacking the negative electrode, the positive electrode, and a separator sheet positioned between the negative electrode and the positive electrode; and
bonding the negative base side edges, the positive base side edges, and the separator sheet.
